(19) United States
(12) Patent Application Publication
(10) Pub. No.: US 2025/0299228 A1
(43) Pub. Date: Sep. 25, 2025

(54) METHODS, APPARATUS, AND SYSTEMS FOR PROGRAMMATIC ADVERTISING USING INTERNET PROTOCOL ADDRESSING

(71) Applicant: Charter Communications Operating, LLC, St. Louis, MO (US)

(72) Inventors: Marc Forman, Princeton Junction, NJ (US); Alexander Groysman, Passaic, NJ (US); Dawn M. Bowen Nelson, Aurora, CO (US)

(21) Appl. No.: 18/609,463

(22) Filed: Mar. 19, 2024

(51) Int. Cl. G06Q 30/0241; G06Q 30/0273; H04L 61/10; H04L 67/02

(52) U.S. Cl. CPC G06Q 30/0277; G06Q 30/0275; H04L 61/10; H04L 67/02

(57) ABSTRACT

The present invention relates to methods, systems, and apparatus using programmatic advertising to provide content to a user of a first Quadrature Amplitude Modulation (QAM) customer premises device located at a first customer premises. An exemplary method embodiment includes the steps of: storing information associating a first Media Access Control (MAC) address of the first QAM customer premises device located at the first customer premises with a first Internet Protocol (IP) address corresponding to the first customer premises; receiving, at a network equipment device, a first message including the first MAC address and information identifying an ad opportunity, the first message not including the first IP address; determining an IP address corresponding to the first MAC address from the stored information; generating an advertisement request including the first IP address; and communicating the generated advertisement request including the first IP address to a supply side platform.

### FIELD OF INVENTION

The present invention relates to methods, apparatus, and systems for arranging for the delivery of content (e.g., ad content) to customer premises equipment devices through the use of programmatic advertising using Internet Protocol addressing on non-Internet Protocol based content delivery networks and/or systems (e.g., Quadrature Amplitude Modulation (QAM) networks and/or delivery systems).

### BACKGROUND OF THE INVENTION

Programmatic advertising is the buying and selling of advertising (ad) inventory through an automated system and/or process typically in real time using for example Real-Time Bidding (RTB). Automated auctions are used in programmatic advertising for determining which advertiser's content will be presented by a device, e.g., to a viewer, during a presentation opportunity, e.g., also sometimes referred to as an impression opportunity or ad opportunity. While impression opportunities may arise during an Internet session, e.g., when a user is browsing the Internet and accessing other content, impression opportunities also arise in the context of content delivery during linear programming and video on demand (VOD) such as for example quadrature amplitude modulated (QAM) communicated television content, video content or other program content supplied via a communications system such as a cable network system. Interactive Advertising Bureau (IAB) has introduced OpenRTB standards for use with programmatic advertising that has been adopted by many ad selling and ad buying entities.

In some prior systems, when advertising inventory originating from QAM devices is auctioned in a programmatic system, it either lacks an IP address entirely or utilizes a placeholder, static IP address, that is not unique to the originating device and does not enable marketers leveraging programmatic systems to decipher geo-location or any unique identification about the device, household or customer premises, effectively limiting the targeting capabilities associated with marketing campaigns executed against the advertising inventory. In such QAM device environments, geo-location targeting, frequency capping, addressable audience targeting, ad pacing and other relevant targeting features are unavailable to marketers.

Furthermore, in some prior systems in an attempt to overcome these problems of limited targetability of QAM devices in programmatic ecosystems, the QAM network operator (e.g., cable service provider) is required to manage all targeting through ad server driven executions leveraging the operator's first party data. This can be costly and expensive for QAM network operators as it requires additional equipment and resources for the QAM network operators to run and manage programmatic auctions and also limits the marketers willing to participate as it also requires first-party audience data be provided from the marketers to be transmitted to the QAM network operators to execute targeting for specific campaigns. This is also time-consuming and costly for the marketers and also requires the exposure of a marketer's first-party data. This further adds burdens and costs to the QAM network operator who must secure the first party data received from the marketers in a privacy compliant manner and adds costs for data sharing integrations which creates burdens for both marketers and QAM network operators (e.g., cable network operators). Furthermore, without information as to the audience of an advertisement the price a QAM network operator (e.g., a cable network operator) can obtain for the ad space from a marketer will be diminished. And, in various instances marketers may decide to not bid at all if there is no indication of the audience to which the ad will be presented.

From the foregoing, it should be understood that there is a need for new and/or improved methods, systems and apparatus to solve the problem of how to efficiently and effectively in a cost and time efficient manner implement programmatic advertising with respect to non-Internet Protocol based content delivery networks and/or systems (e.g., Quadrature Amplitude Modulation (QAM) networks and/or delivery systems) while enabling marketers to implement audience targeting features such as geo-location targeting, frequency capping, addressable audience targeting, and ad pacing currently unavailable to marketers campaigns executed against the advertising inventory of non-IP networks such as QAM networks.

From the foregoing, it should also be understood that there is a need for new and/or improved methods, systems and apparatus that will allow marketers to retain their first-party data in a privacy compliant manner, expedite the ease and timeliness of execution of programmatic advertising auctions of ad inventory, and eliminate the need for costly data sharing integrations that create burdens for both marketers and non-Internet Protocol networks (e.g., cable network systems QAM network operators) while allowing marketers to implement various audience targeting features such as geo-location targeting, frequency capping, addressable audience targeting, and ad pacing.

Furthermore, there is a need for new and/or improved methods, systems, and apparatus for enabling audience targeting advertising to QAM devices in a manner that is compliant with Interactive Advertising Bureau (IAB) OpenRTB standards.

### SUMMARY OF THE INVENTION

Various embodiments of the present invention provide new and/or improved methods and apparatus for, among other things, enabling marketers to implement audience targeting features such as geo-location targeting, frequency capping, addressable audience targeting, and ad pacing in marketing campaigns executed against the advertising inventory of non-IP networks such as QAM networks. Various embodiments of the present invention provide new and/or improved methods, systems, and apparatus for implementing programmatic advertising with audience targeting to QAM devices in cable networks without the cable network operator having to manage the ad targeting through use of its first party data and/or the first party data of marketers. Various embodiments of the present invention solve one or more of the problems discussed above.

Various embodiments of the present invention enable non-IP network operators such as QAM network operators (e.g., cable network service providers) who also operate IP networks within the same households to cross-map the devices in otherwise disconnected networks and leverage common data elements to enhance monetization of non-IP network (e.g., QAM network) advertising inventory. By matching IP addresses from devices in the same household to QAM devices, a QAM network operator can adhere to IAB OpenRTB standards and allow buyers in a programmatic advertising system to leverage the enhanced data elements for geo-location targeting, frequency capping, addressable audience targeting and other relevant targeting that would otherwise be unavailable in QAM device environments. In various embodiments of the present invention, a QAM device MAC address is associated with IP address information of an IP device located in the same household and/or at the same customer premises. QAM network operators can then include in bid requests offering ad opportunities for ad impressions to be presented to the QAM device the IP address associated with the MAC address of the QAM device. The marketers can then use the IP address information for implementing advertising targeting features such as audience targeting advertising, geo-location advertising, frequency capping, ad spacing, etc.

An exemplary method of providing content to a user of a first Quadrature Amplitude Modulation (QAM) customer premises device located at a first customer premises in accordance with one embodiment of the present invention includes the steps of: storing information (e.g., in a storage device included in a customer data platform of a cable service provider) associating a first Media Access Control (MAC) address of the first QAM customer premises device located at the first customer premises with a first Internet Protocol (IP) address corresponding to the first customer premises; receiving, at a network equipment device (e.g., a VOD ad router or an advertisement (ad) server), a first message including information identifying an opportunity for the presentation of content (e.g., an ad) and the first MAC address, said first message not including the first IP address; determining an IP address corresponding to the first MAC address from the stored information (e.g., by operating the network equipment device to contact a customer data platform to request IP address information corresponding to the first MAC address and receiving from the customer data platform an IP address corresponding to the first MAC address from the stored information); generating (e.g., at the network equipment device) an advertisement (ad) request (e.g., a request for an ad impression or an opportunity to display an ad), said ad request including the first IP address; and communicating the generated ad request including the first IP address to a supply side platform (SSP).

In some embodiments, an operator operates both a cable network system providing QAM sessions to the first QAM customer premises device located at the first customer premises and an Internet Protocol network system providing Internet services to a first IP device (e.g., an IP streaming device) with the first IP address also located at the first customer premises. In some such embodiments, the cable network system's distribution network for providing QAM sessions to the first QAM customer premises device is separate and different from the Internet Protocol network system's distribution network through which content is provided to the first IP device. In some embodiments, the operator uses a household identifier to identify the first customer premises.

In some embodiments, the network equipment device is a VOD ad router, and the VOD ad router generates the ad request. In some such embodiments, the step of communicating the generated ad request including the first IP address to a supply side platform (SSP) includes communicating the ad request from the VOD ad router to the SSP via an Ad server.

In some embodiments, the method further includes modifying by the ad server the ad request as the ad request is communicated to the SSP, said modifying including re-formatting, adding, deleting and/or changing information about the opportunity to present an ad (e.g., adding information for generating a real-time bid request, filtering information, information about requirements for the ad impression, bid pricing information, publisher identification information, etc.).

In some embodiments, the network equipment device is an Ad server; and the first message is an ad request message including the first MAC address which is received by the Ad server from an Ad router with both the Ad server and Ad router being part of a cable network system.

In some embodiments, the method further includes the step of: receiving, at an ad server, from the SSP information (e.g., a winning bid response to an advertisement bid request) identifying content (e.g., an advertisement, creative or media content for an impression corresponding to the winning bid response) to be supplied to the first QAM customer premise device as part of a QAM session.

In some embodiments, the method further includes the step of: operating the ad server to initiate delivery of the identified content in the QAM session to the first QAM customer premises device.

In some embodiments, the QAM session is a Video-on-Demand (VOD) session which was initiated by the first QAM customer premises device by sending a VOD request message to a network headend, said VOD request message including the first MAC address.

In some embodiments, the first IP address is an IP address of an IP device located at the first customer premises (e.g., an IP video streaming device or another IP device).

In some embodiments, the step of storing information (e.g., in a storage device included in a customer data platform of a cable service provider) associating a first MAC address of the first QAM customer premises device located at the first customer premises with a first IP address corresponding to the first customer premises includes: storing the first MAC address in a table, said first IP address being associated in said table with the first MAC address (e.g., the association information is the first household identifier which is associated with first IP address in a second table). In some such embodiments, the table further includes a first household identifier corresponding to the first customer premises used by a cable network service provider to identify a first household to which the first customer premises corresponds.

In some embodiments, the step of determining the IP address corresponding to the first MAC address from the stored information includes: determining a household identifier corresponding to the first MAC address, said household identifier corresponding to the first MAC address being the first household identifier; and determining from the determined household identifier an IP address corresponding to the determined household identifier, the determined IP address being the first IP address.

In some embodiments, the step of operating the ad server to initiate delivery of the identified content in the QAM session to the first QAM customer premises device includes: operating the ad server to send a message to a VOD ad router, said message instructing the VOD Ad router to provide the identified content (e.g., the ad) to a QAM VOD content server for insertion into a QAM VOD content stream being provided to the first QAM customer premises device as part of the QAM VOD session. In some such embodiments, the VOD ad router is used to provide the identified content (e.g., the ad) to the VOD content server.

In some embodiments, the method further includes the step of inserting, by the VOD content server, the identified content (e.g., ad) into the QAM VOD content stream in response to receiving the identified content from the VOD ad router.

In some embodiments, the method further includes the steps of receiving the identified content (e.g., ad) at the first QAM customer premises device from the VOD content server; outputting the identified content (e.g., ad) to a playback device; and outputting the identified content (e.g., ad) from the playback device to the user. In some embodiments, the QAM customer premises device is a QAM set-top cable box; and the playback device is a display device (e.g., a television set). In some embodiments, the method further includes the steps of: receiving the identified content (e.g., ad) at the first QAM customer premises device from the VOD content server; and outputting, by the first QAM customer premises device, the identified content to a display. In some such embodiments, the first QAM customer premises device includes the display.

In some embodiments, the method further includes the step of: receiving the ad request at the supply side platform. In some embodiments, the ad request includes in addition to the first IP address, one or more of the following: quantity of ad opportunities, publisher identifier information, an ad opportunity identifier, price floor information, device information for the first QAM customer premises device (e.g., device type, manufacturer, operation system version, hardware version, software version, display size), filtering information, specifications for identified content.

In some embodiments, the method further includes the steps of: receiving the ad request at the supply side platform; generating, at the supply side platform, a real-time bid request based on information included in the ad request, said real-time bid request including the first IP address; communicating from the supply side platform the real-time bid request to a demand side platform; receiving the real-time bid request at the demand side platform; communicating the real-time bid request from the demand side platform to one or more Marketer Ad Servers; and receiving at the one or more Marketer Ad Servers the communicated real-time bid request.

In some embodiments, the real-time bid request is an IAB OpenReal-time bid request (ORTB bid request) (e.g., OpenRTB request in accordance with the OpenRTB protocol (e.g., OpenRTB 3.0 (Real-Time Bidding) specification and/or AdCOM specification v1.0 dated March 2022).

In some embodiments, the identified content is an advertisement. In some embodiments, the identified content is an advertisement including audio and video content. In some embodiments, the identified content is a creative. In some embodiments, the identified content is content previously stored in the Ad server.

In some embodiments, the method further includes performing by one of the following: the supply side platform, the demand side platform or a Marketer Ad Server a frequency capping operation based on the first IP address included in the real-time bid request. In some such embodiments, the frequency capping operation based on the first IP address includes limiting the number of times the same content (e.g., ad) is presented to a device associated with the first IP address in a first period of time.

In some embodiments, the frequency capping operation based on the first IP address is performed by a Marketer Ad Server, said frequency capping operation performed by the Marketer Ad Server including: refraining from sending a real-time bid response identifying content (e.g., an ad) that is the same as content (e.g., an ad) previously provided a first threshold number of times within a first period of time to a device associated with the first IP address.

In some embodiments, the method further includes the step of: using, by one or more of the Marketer Ad servers which receive the real-time bid request, the first IP address included in the real-time bid request to perform addressable audience targeting advertising.

In some embodiments, the step of performing addressable audience targeting advertising includes: determining advertising content (e.g., specific ad content) to include in a real-time bid response to the real-time bid request based on information corresponding to the first IP address (e.g., information about prior clicks on website links requesting information on pricing and options for offered products and/or services).

In some embodiments, the information corresponding to the first IP address is proprietary first party data of the marketer operating the Marketer Ad server.

In some embodiments, the method further includes the step of: using, by one or more of the Marketer Ad servers which receive the real-time bid request, the first IP address included in the real-time bid request to implement geo-location based targeted advertising.

In some embodiments, the method further includes the steps of: determining, by a first Marketer Ad server which received the real-time bid request, a geo-location corresponding to the first IP address; and determining, by the first Marketer Ad server, whether or not to send a real-time bid response in response to the real-time bid request based on the determined geo-location.

In some embodiments, the method further includes the steps of: determining, by a first Marketer Ad server which received the real-time bid request, a geo-location corresponding to the first IP address; and determining, by the first Marketer Ad server, content (e.g., ad content) to include in a real-time bid response in response to the real-time bid request based on the determined geo-location (e.g., ad content for an amusement park is included if the geo-location corresponding to the first IP address is within 50 miles of the location of the amusement park, ad content for a politician is included if the geo-location corresponding to the first IP address is within the voting district for the politician).

In some embodiments, the method further includes the step of: using, by a first Marketer Ad server which receives the real-time bid request, first party data of the first Marketer Ad server operator corresponding to the first IP address included in the real-time bid request to implement geo-location based targeted advertising without first party data of the cable network operator, the cable network operator operating the cable network over which the content identified content (e.g., ad) in a winning bid response is to be supplied to the first QAM device.

In some embodiments, the method further includes the steps of: obtaining, by a first Marketer Ad server, which receives the real-time bid request, information about the first IP address (e.g., first party information of the first Marketer Ad server stored in a storage device connected to or part of the first Marketer Ad server), said information not being obtained from a cable network operator operating the network equipment device which generated the ad request; and using, by the first Marketer Ad server, the obtained information in determining a price and/or content (e.g., ad content) to include in a real-time bid response in response to the real-time bid request.

In some embodiments, the method further includes the steps of: generating, at one or more of the Marketer Ad Servers that received the communicated real-time bid request, a real-time bid response to the real-time bid request, each of said real-time bid responses generated including information identifying content (e.g., ad content of the individual marketer generating the real-time bid response) to be supplied to the first QAM customer premises device as part of a QAM session and a price; communicating, by each of the Marketer Ad Servers which generated real-time bid responses, the generated real-time bid response to the demand side platform (DSP) in response to the real-time bid request; receiving the real-time bid responses from each of the Marketer Ad Servers at the DSP; and communicating the real-time bid responses from the DSP to the SSP in response to the real-time bid request received from the SSP.

In some embodiments, the method further includes the steps of: receiving at the SSP the real-time bid responses from the DSP; determining which of the received real-time bid responses is the winning real-time bid response based on information contained in the real-time bid response and/or the ad request (e.g., applying filtering, frequency capping, pacing instructions provided in the ad request); and communicating from the SSP to an Ad server the information (e.g., the winning bid response) identifying content to be supplied to the first QAM customer premises device as part of the QAM session. The Ad server in such embodiments is a cable network system device via which the ad request is communicated to the SSP such as for example from a VOD ad router via the Ad server to the SSP.

In some embodiments, the first IP address is included in a device object of a real-time bid request generated by the SSP (e.g., the first IP address being included in the ip or ipv6 attribute of the device object included in an Interactive Advertising Bureau (IAB) OpenRTB bid request in accordance with the OpenRTB protocol (e.g., OpenRTB 3.0 (Real-Time Bidding) specification and/or AdCOM specification v1.0 dated March 2022). with AdCOM specification v1.0 dated March 2022).

In some embodiments, one or more of the real-time bid responses received by the SSP are OpenRTB bid responses (e.g., OpenRTB responses in accordance with the OpenRTB protocol (e.g., OpenRTB 3.0 (Real-Time Bidding) specification and/or AdCOM specification v1.0 dated March 2022).

Another exemplary method embodiment of providing content to a user of a first Quadrature Amplitude Modulation (QAM) customer premises device located at a first customer premises includes the steps of: storing information (e.g., in a storage device included in a customer data platform of a cable service provider) associating a first Media Access Control (MAC) address of the first QAM customer premises device located at the first customer premises with a first Internet Protocol (IP) address corresponding to the first customer premises; receiving, at a cable network system, a request for Video-on-Demand content including the first MAC address, said request for Video-on-Demand content not including the first IP address; determining, by the cable network system, an IP address corresponding to the first MAC address from the stored information (e.g., by querying the customer data platform to request IP address information corresponding to the first MAC address and obtaining from the customer data platform an IP address corresponding to the first MAC address from the stored information); generating, by the cable network system (e.g., by an ad router and/or an ad server of the cable network system) an advertisement (ad) request (e.g., a request for an ad impression or an opportunity to display an ad), said ad request including the first IP address; and communicating the generated ad request including the first IP address to a supply side platform (SSP).

The present invention is also applicable to and includes apparatus and systems such as, for example, apparatus and systems that implement the steps and/or functions of the method embodiments. For example a system including a network equipment device, said network equipment device including: memory; and a first processor, said first processor controlling the network equipment device to perform the following operations: receiving, at the network equipment device, a first message including information identifying an opportunity for the presentation of content (e.g., an ad) and a first MAC address, said first message not including a first IP address; determining a first IP address corresponding to the first MAC address from stored information (e.g., by operating the network equipment device to contact a customer data platform to request IP address information corresponding to the first MAC address and receiving from the customer data platform an IP address corresponding to the first MAC address from stored information in the customer data platform, said IP address being the first IP address), said stored information associating the first Media Access Control (MAC) address of the first QAM customer premises device located at the first customer premises with a first Internet Protocol (IP) address corresponding to the first customer premises; generating (e.g., at the network equipment device) an advertisement (ad) request (e.g., a request for an ad impression or an opportunity to display an ad) including the first IP address; and communicating the generated ad request including the first IP address to a supply side platform (SSP).

In some embodiments, one or more of the devices, apparatus, systems and/or platforms (e.g., customer data platform, supply side platform, and data side platform) include memory and one or more processors. The memory including instructions which when executed by the one or more processors control the device, apparatus, system, or platform to perform one or more of the functions, operations or steps of the methods described herein. In some embodiments, one or more of the devices, apparatus, systems and/or platforms are implemented as virtual devices or applications executing on nodes including processing hardware in a cloud environment.

While various embodiments have been discussed in the summary above, it should be appreciated that not necessarily all embodiments include the same features and some of the features described above are not necessary but can be desirable in some embodiments. Numerous additional features, embodiments and benefits of various embodiments are discussed in the detailed description which follows.

### BRIEF DESCRIPTION OF THE DRAWINGS

FIG. 1 illustrates an exemplary system in accordance with an embodiment of the present invention.

FIG. 2 illustrates an exemplary method and signaling flow in accordance with an embodiment of the present invention.

FIG. 3 comprises FIG. 3A, FIG. 3B, FIG. 3C, FIG. 3D, FIG. 3E, and FIG. 3F.

FIG. 3A is the first part of a flowchart of an exemplary method in accordance with an embodiment of the present invention.

FIG. 3B is the second part of a flowchart of an exemplary method in accordance with an embodiment of the present invention.

FIG. 3C is the third part of a flowchart of an exemplary method in accordance with an embodiment of the present invention.

FIG. 3D is the fourth part of a flowchart of an exemplary method in accordance with an embodiment of the present invention.

FIG. 3E is the fifth part of a flowchart of an exemplary method in accordance with an embodiment of the present invention.

FIG. 3F is the sixth part of a flowchart of an exemplary method in accordance with an embodiment of the present invention.

FIG. 4 illustrates a plurality of different QAM VOD Ad request messages.

FIG. 5 illustrates an exemplary bid request in accordance with an embodiment of the present invention.

FIG. 6 illustrates an exemplary bid response in accordance with an embodiment of the present invention.

FIG. 7 is a drawing of an exemplary communications and/or processing device in accordance with an exemplary embodiment.

FIG. 8 illustrates an exemplary assembly of components 800 which may be included in an exemplary communications and/or processing device in accordance with an exemplary embodiment of the present invention.

FIG. 9 illustrates an exemplary customer data platform 900 including multiple mapping tables in accordance with an embodiment of the present invention.

FIG. 10 illustrates another exemplary method and signaling flow in accordance with an embodiment of the present invention.

### DETAILED DESCRIPTION

Various method, system, and apparatus embodiments of the present invention as discussed above enable quadrature amplitude modulation (QAM) network operators (e.g., QAM network operators) who also operate Internet Protocol networks within the same households or customer premises to cross-map the QAM devices and Internet Protocol devices in otherwise disconnected networks and leverage common data elements (e.g., a household identifier corresponding to the customer premises which maps an Internet Protocol address of an Internet Protocol device located at the customer premises to a QAM device located at the same customer premises (i.e., co-located in the same household) to enhance monetization of QAM advertising inventory (i.e., ad space). By matching IP addresses from devices in the same household at the same customer premises to QAM devices, the operator can adhere to Interactive Advertising Bureau (IAB) OpenRTB standards and allow buyers in a programmatic advertising system to leverage the enhanced data elements (IP address information in bid requests for QAM devices) for geo-location targeting, frequency capping, addressable audience targeting and other relevant targeting that would otherwise be unavailable in QAM device environments.

As previously explained in some systems, when advertising inventory originating from QAM devices is auctioned in a programmatic system, it either lacks an IP address entirely or utilizes a placeholder, static IP address, that is not unique to the originating device and does not enable marketers leveraging programmatic systems to decipher geo-location or any unique identification about the device, household or customer premises, effectively limiting the targeting capabilities associated with marketing campaigns executed against the advertising inventory.

Various embodiments of the present invention enable QAM device operators who also operate IP devices within the same households to cross-map the devices in other disconnected networks and match IP address and MAC address data elements, when available, to replace the static IP address placeholder and instead utilize a unique IP address identifier that can be deciphered by programmatic systems to determine geo-location and audience participation of the associated QAM device advertising inventory (e.g., ad space). The present invention allows for marketers to target QAM devices and allow programmatic ecosystems to utilize IP addresses for geo-location targeting and unique identification as well as the implementation of pacing of ads, frequency capping of ads, and content selection of ads based on IP addresses.

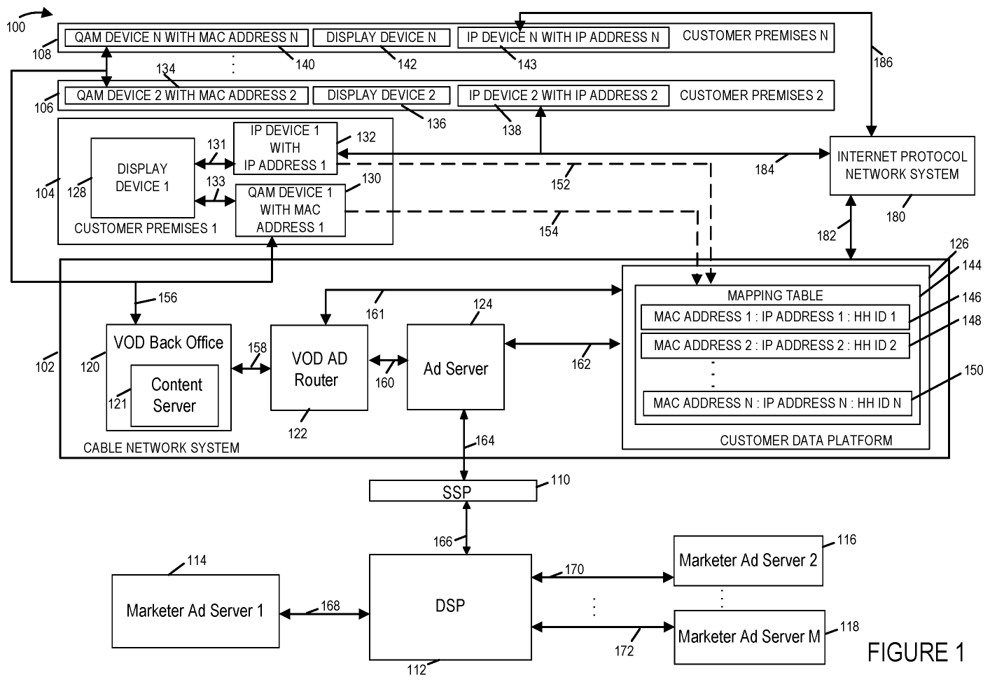

FIG. 1 illustrates an exemplary system in accordance with an embodiment of the present invention. System 100 includes a cable network system 102, an Internet Protocol network system 180, a plurality of customer premises (customer premises 1 104, customer premises 2 106, . . . , customer premises N 108 where N is an integer greater than 2), a Supply Side Platform (SSP) 110, a Demand Side Platform 112, and a plurality of Marketer Ad Servers (Marketer Ad Server 1 114, Marketer Ad Server 2 116, . . . , Marketer Ad Server M 118 where M is an integer greater than 2). The elements of the system are coupled and/or connected together via communications links.

In the exemplary system 100, the cable network system 102 and Internet Protocol network system 180 are operated by the same operator. The Internet Protocol network and the cable network have separate communications links to the customer premises 1 104, customer premises 2 106, . . . , customer premises N 108.

The cable network 102 includes a Video-on-Demand (VOD) Back Office 120, a Video-on-Demand Advertisement router (VOD Ad router) 122, an Advertisement Server (Ad Server) 124, and a customer data platform 126. The VOD Back Office 120 includes a content server 121 (e.g., a Video-on-Demand content server). The customer data platform 126 includes a mapping table 144 typically included in a storage device or memory of the customer data platform 126. In some embodiments, the mapping table 144 is included in a storage device, e.g., a database server, coupled and/or connected to the customer data platform. The elements of the cable network system 102 are coupled and/or connected via communications links so that they can exchange signals, information, data and messages. Equipment in the VOD Back Office 120 is coupled and/or connected to the VOD Ad router 122 via communications link 158. The VOD Ad router is coupled and/or connected to the Ad server 124 via communications link 160. The VOD Ad router is coupled and/or connected to the customer data platform 126 via communications link 161. In some, but not necessarily all, embodiments, the Ad Server 124 is coupled and/or connected to the customer data platform 126 via communications link 162. The cable network system 102 is coupled and/or connected to the SSP 110. Communications link 164 couples and/or connects the Ad server 124 of the cable network system 102 to the SSP 110. The SSP 110 is coupled and/or connected to the DSP 112 via communications link 166. The DSP 112 is coupled and/or connected to the Marketer Ad server 1 114, the Marketer Ad server 2 116, . . . , Marketer Ad server M 118 via communications links 168, 170, . . . , 172 respectively.

The customer premises 1 104 includes a display device 1 128 (e.g., a television), a Quadrature Amplitude Modulation (QAM) device 1 130 with a Media Access Control (MAC) address 1 (e.g., a set-top box), and an Internet Protocol (IP) device 1 132 with an IP address 1 (e.g., an IP streaming device, computer, etc.), The display device 1 128 is coupled and/or connected to the IP device 1 132 via communications link 131 and to the QAM device 1 130 via communications link 133.

The customer premises 2 106 includes a display device 2 136 (e.g., a television), an Internet Protocol (IP) device 2 138 with an IP address 2 (e.g., an IP streaming device, computer, etc.), and a Quadrature Amplitude Modulation (QAM) device 2 134 with a MAC address 2 (e.g., a set-top box). The display device 2 136 is coupled and/or connected to the IP device 2 138 and the QAM device 2 134.

The customer premises N 108 includes a display device N 142 (e.g., a television), an Internet Protocol (IP) device N 143 with an IP address N (e.g., an IP streaming device, computer, etc.), and a Quadrature Amplitude Modulation (QAM) device N 140 with a MAC address N (e.g., a set-top box). The display device N 142 being coupled and/or connected to the IP device N 143 and the QAM device N 140. Each of the MAC addresses corresponding to the QAM devices 1, 2, . . . , N is different. Each of the IP addresses corresponding to the IP devices 1, 2, . . . , N is different. That is each of the MAC addresses: MAC address 1, MAC address 2, . . . , MAC address N has a different value; and, each of the IP addresses: IP address 1, IP address 2, . . . , IP address N has a different value.

For each of customer premises 1 104, customer premises 2 106, . . . , customer premises N 108 information is stored in the customer data platform 126 associating the MAC address of the QAM device located at a customer premises with the IP address of the IP device located at the same customer premises. In various embodiments, information identifying a household or customer to which a customer premises corresponds is also included in the customer data platform 126. In various embodiments, this information is a household identifier (HH ID) which is assigned to and/or associated with a customer premises and is also associated with the MAC address of the QAM device located at the customer premises and the IP address of the IP device located at the customer premises. For example, household ID 1 assigned to customer premises 1 104 is associated with MAC address 1 of QAM device 1 and IP address 1 of IP device 1 which are located at customer premises 1 104.

In the exemplary data platform 126, a mapping table 144 is included which includes entries 146, 148, . . . , 150. The entry 146 includes MAC address 1: IP address 1: Household (HH) ID 1. The entry 148 includes MAC address 2: IP address 2: HH ID 2. The entry 150 includes MAC address N: IP address N: HH ID N. As explained above, each of the household identifiers (HH identifiers) is used by the cable network operator of the cable network system 102 to identify a household or customer to which a customer premises corresponds. The HH ID 1 identifies a first household or first customer to which the customer premises 1 104 corresponds. The HH ID 2 identifies a second household or second customer to which the customer premises 1 106 corresponds. The HH ID N identifies the Nth household or Nth customer to which the customer premises N 108 corresponds. For each of customer premises 1 104, customer premises 2 106, . . . , customer premises N 108 information is stored in the customer data platform 102 associating the MAC address of the QAM device located at the customer premises with the IP address of the IP device located at the same customer premises. Table 144 maps and/or associates the MAC address, IP address and HH ID corresponding to each of the customer premises of the system 100. Dashed lines 152 and 154 represent the logical association of the MAC Address 1 for the QAM device 1 130 and the IP address 1 for IP device 1 132 in the mapping table 144 entry 146 of the customer data platform.

In some embodiments, multiple tables are utilized in the customer data platform 126 to associate the MAC address of a QAM device with the IP address of an IP device located at the same customer premises. For example, in some embodiments two tables are utilized. The first table includes a MAC address for a QAM device located at a customer premises which is associated with a Household ID corresponding to the customer premises at which the QAM device is located. The second table includes Household IDs corresponding to each customer premises associated with the IP address of the IP device located at the customer premises. The household ID in such embodiments is information which associates the MAC address of a MAC device a customer premises with the IP address of an IP device at the same customer premises.

While in the exemplary embodiment table entries have been used to associate the MAC address of the QAM device with IP address of the IP device at the same customer premises, one of skill in the art would appreciate that other data structures such as records, linked lists, etc. can be used to associate the MAC address of the QAM device with the IP address of the IP device at the same customer premises.

The content server 121 streams content (e.g., VOD content and ad content) to Quadrature Amplitude Modulation (QAM) devices (e.g., set-top boxes) located at customer premises being serviced by the cable network system 102 (e.g., QAM device 1 130, QAM device 2 134, . . . , QAM device N 140).

The cable network system 102 is coupled/connected to the QAM devices on customer premises being serviced by the cable network system (e.g., QAM device 1 130, QAM device 2 134, . . . , QAM device N 140) via cable network 156. The cable network 156 is a set of communications links which couple and/or connect the equipment in the VOD back office 120 including the content server 121 to the QAM device 1 130, QAM device 2 134, . . . , QAM device N 140 located at the first customer premises 104, the second customer premises 104, . . . , the Nth customer premises 108. In some embodiments, one or more of the following elements are included in a cable headend of the cable network system 102: the VOD Back Office 120, the content server 121, the VOD Ad router 122, the Ad server 124, the customer data platform 126.

The Internet Protocol network system 180 is coupled and/or connected to the IP devices located at customer premises via a communications network consisting of a plurality of communications links 184 and 186. The communications link 184 couples and/or connects the Internet Protocol network system 180 to IP device 1 132 located at the customer premises 1 104 and IP device 2 located at customer premises 2 106. The communications link 186 couples and/or connects the Internet Protocol network system 180 to the IP device N located at the customer premises N.

The Internet Protocol network system 180 is coupled and/or connected to the cable network system 102 (e.g., the customer data platform 126 of the cable network system 102) via communications link 182. The communications link 182 is used to exchange information such as customer premises mapping information (e.g., IP address information and HouseHold Identifier information for each customer premises) from the IP network system 180 to the customer data platform 126 of the cable network system so that it can be mapped to the MAC address information for QAM devices at the same customer premises. The IP network system 180 distribution network and the cable network system distribution network are typically not interconnected but are independent with the cable network system content being supplied via a first set of network communications links typically using QAM and the Internet Protocol network system content is provided via a second set of network communications links.

The elements of the system 100 are coupled and/or connected together via communications links 131, 133, 156, 158, 160, 161, 162, 164, 166, 168, 170, 172, 182, 184, 186. The communications links are typically wired and/or optical cables but one or more of the communications links may be, and in some embodiments are, wireless communications links such as for example the communications link 131 which couples and/or connects the IP device 1 132 with the display device 1 128.

The VOD Ad Router 122, Ad Server 124, SSP 110, DSP 112, Marketer Ad Server 1 114, Marketer Ad Server 2 116, . . . , Marketer Ad Server M 118 are used to implement programmatic advertising. In some embodiments, these elements implement Interactive Advertising Bureau (IAB) OpenRTB protocol and comply with IAB specifications (e.g., OpenRTB 3.0 (Real-Time Bidding) specification and/or AdCOM specification v1.0 dated March 2022 AdCOM specification v1.0 dated March 2022).

At a high level programmatic advertising is the automated electronic buying and selling of ad space or opportunities referred to as ad impressions via an electronic auction. In the system 100 the cable network system operator is the publisher who has ad space also referred to as ad inventory to sell to marketers or advertisers. The cable network system includes the Ad router 122 and Ad server 124 which are responsible for generating ad requests for selling ad space or ad opportunities (e.g., ad opportunities to be presented to QAM devices) and communicating the Ad requests to the SSP 110 for execution. The ad requests for QAM devices include an IP address associated with the MAC address of the QAM device when such IP address information is available. The SSP 110 is a platform, e.g., a server, system or device, which allows publishers including the cable network operator to manage their ad space or inventory. Among the SSP 110 responsibilities are the generation and submission of bid requests for ad opportunities to DSP 112 and the determination of a winning bid response from bid responses received from the DSP 112. The DSP 112 is a platform, e.g., a server, system or device, which allows marketers/advertisers to manage their marketing campaigns. Among the DSP 112 responsibilities are receiving of bid requests from the SSP 110 as well as the processing and distribution of the bid requests to marketer ad servers to which it is providing services. The DSP 112 also receives bid responses to the bid requests from the marketer ad servers, processes the bid responses and communicates them to the SSP 110 which determines the winning bid response. The marketer ad servers are used by the marketers for among other things to receive bid requests, process the bid requests, generate bid responses, and communicate the bid responses to the DSP 112.

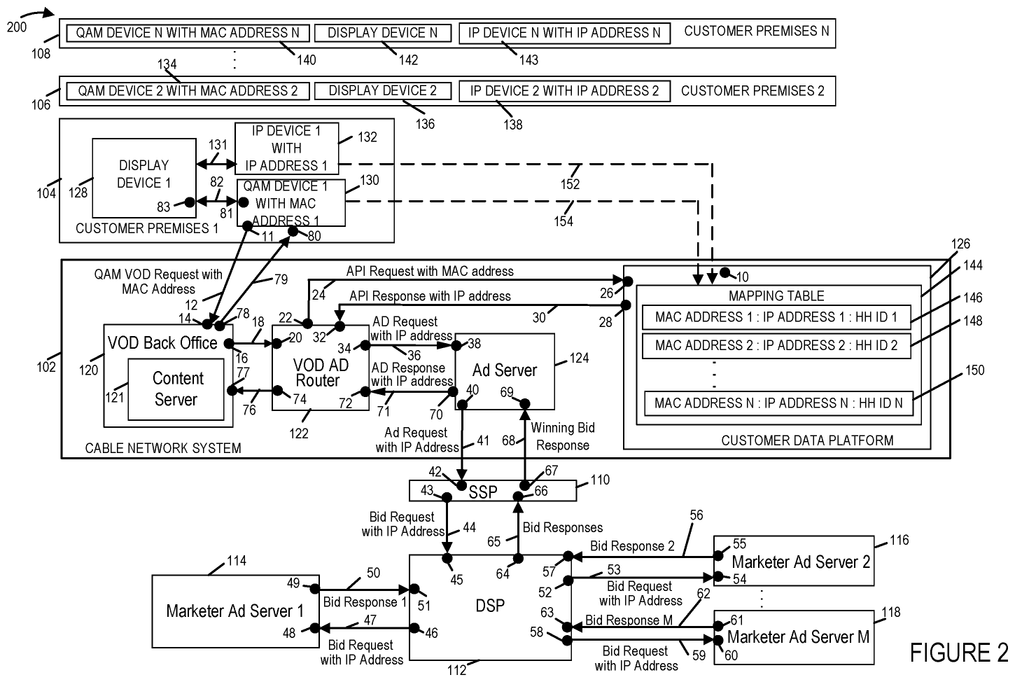

FIG. 2 illustrates a signaling diagram which illustrates the steps and signaling of an exemplary method 200 in accordance with an embodiment of the present invention.

While it will be readily understood that additional steps and signaling are performed in connection with communicating information, messages, and packets between devices, the method 200 focuses on and discusses the steps and signaling for understanding the invention. Elements or steps with the same reference numbers used in different figures are the same or similar and those elements or steps will not be described in detail again. The exemplary signaling diagram/method 200 is implemented on exemplary system 100 with only those elements of the system 100 necessary for understanding the invention being shown in FIG. 2. For example, the communications links on which the signals/messages are communicated between devices is not illustrated. The signaling diagram/method 200 may be, and in some embodiments is, implemented using other systems other than system 100 and/or other system architectures.

The method 200 starts in step 10 shown on FIG. 2. In step 10, information is stored in the customer data platform 126 of the cable server provider operating the cable network system 102. The information associating MAC addresses of QAM devices with IP addresses of IP devices located at the same customer premises. This includes storing information associating MAC address 1 for QAM device 1 130 located at customer premises 1 104 with IP address 1 for IP device 1 132 also located at customer premises 1 104. In some embodiments, the MAC address of the QAM device and the IP address of the IP device located at a customer premises is also associated with a household identifier used to identify a household located at the same customer premises. In this example, the MAC address 1 for QAM device 1 130 and the IP address 1 for IP device 1 132 both of which are located at customer premises 1 104 are associated with household (HH) ID 1 in table entry 146 of mapping table 144 of customer date platform 126. Entry 148 in mapping table 144 includes information associating the MAC address 2 of QAM device 2, the IP address 2 of IP device 2, and the HH ID 2 for customer premises 2 106. Entry 150 in mapping table 144 includes information associating the MAC address N of QAM device N, the IP address N of IP device N, and the HH ID N for customer premises N 108. The information for the IP address of the IP device located at the customer premises is supplied by the Internet Protocol network system operator which is also the operator of the cable network system. In some embodiments, one or more of the QAM devices of the system 100 are cable set-top boxes. In some embodiments, one or more of the IP devices of the system 100 are media streaming IP devices. In some embodiments, one or more of the IP devices are IP routers (e.g., routers supplied by the Internet service provider (i.e., the operator of the Internet Protocol network system)). Operation proceeds from step 10 to step 11.

In step 11, the QAM device 130 located at customer premises 1 104 receives an input from a user of the QAM device 130 indicating the selection of video-on-demand content. In response to the input, the QAM device 130 generates a QAM video-on-demand (VOD) request message 12 for the selected content (e.g., a movie) and transmits the VOD request message 12 to equipment in the Video-on-Demand back office 120 (e.g., content server 121). The VOD back office 120 may be, and in some embodiments is or is part of, a cable headend of the cable network system 102. The QAM VOD request message 12 includes the MAC address of the QAM device 1 130 which is MAC address 1 and a content identifier which identifies the selected VOD content. Operation proceeds from step 11 to step 14.

At step 14, equipment in the VOD back office 120 (e.g., the content server 121) receive the QAM VOD request message 12. Operation proceeds from step 14 to step 16.

In step 16, in response to receiving the QAM VOD request message 12, equipment in the VOD back office 120 (e.g., the content server 121) generate Ad opportunity message 18 based on the received QAM VOD request message 12 and transmits the Ad opportunity message 18 to the VOD Ad router 122. The Ad opportunity message 18 includes the MAC address 1 of the QAM device 1 130 which was included in the QAM VOD request message 12. The Ad opportunity message 18 includes the information identifying one or more opportunities for which ads and/or other content (e.g., public announcements) may be inserted into a QAM VOD stream to be provided in response to the QAM VOD request message 12. For example, if the video-on-demand content being requested is a movie which lasts one hour there will be N opportunities to insert ads into the VOD stream, N being a positive integer (e.g., when N=6 there will be an opportunity for 6 ads to be inserted into the VOD stream). In some embodiments, the Ad opportunity message 18 also includes information about the selected VOD content which can be used in determining ad content (e.g., content identifier, information indicating it is for VOD, video title, audience rating (G, PG, PG-13, R, X, NR, mature audiences, children, teens, adults), video content type or category—children's programming, adult programming, educational programming (e.g., documentary about automobiles, politics, history), etc.) and/or information on the method of delivery of the selected content (e.g., via QAM transmission) and/or when the content will be delivered with respect to each ad opportunity such as for example at the beginning of a program, during the program or at the conclusion of the program. Operation proceeds from step 16 to step 20.

In step 20, the VOD Ad router 122 receives the Ad opportunity message 18 which includes the MAC address 1 of QAM device 1 130 and information identifying one or more opportunities for inserting an ad or other content into the VOD stream to be provided in response to the QAM VOD request message 12. In some embodiments, the VOD Ad router 124 determines that the Ad opportunity or Ad opportunities identified in the Ad opportunity message 18 is for a QAM VOD session (e.g., based on one or more of the following: the MAC Address included in the Ad opportunity message 18, information included in the Ad opportunity message 18, and/or that the ad opportunity message 18 was received from the equipment in the VOD Back Office 120 (e.g., content server 121). Operation proceeds from step 20 to step 22.

In step 22, the VOD Ad router 122 generates and transmits message 24 to the customer data platform 126. The message 24 in some embodiments includes or is based on the Ad opportunity message 18. The message 24 includes the MAC address 1 and requests an IP address associated with the MAC address 1. In some embodiments, the message 24 is a query message including the MAC address 1 of the QAM device 1 130 requesting an IP address which is associated with the MAC address 1. In some embodiments, the message 24 is an Application Programming Interface (API) request including the MAC address 1. Operation proceeds step 22 to step 26.

In step 26, the customer data platform 126 receives the message 24. Operation proceeds from step 26 to step 28.

In step 28, the customer data platform 126 performs a query or search of information stored in the Customer Data Platform 126 based on and/or using the MAC address included in the message 24 (MAC address 1) for an IP address associated with the MAC address included in the message 24. In this example, the Customer Data Platform 126 performs a search of the mapping table 144 based on the MAC Address 1 and determines from the table entry 146 that IP address 1 is associated with MAC address 1. Upon identifying and retrieving MAC address 1 from the mapping table 144 entry 146, the customer data platform 126 generates message 30 and transmits message 30 to VOD AD router 122 in response to the received message 24. The message 30 includes the IP address 1 which was associated with the MAC address 1 in the mapping table 144. In some embodiments, when message 24 is implemented as an API request with the MAC address 1 provided in message 18, the message 30 is provided as an API response including the requested IP address associated with the MAC address 1. In some embodiments, the mapping table 144 is included in a storage device, e.g., a database server system, separate from but connected and/or coupled to the customer data platform 126. In such embodiments, the customer data platform performs the step of querying the storage device for an IP address which is associated with the MAC address 1. In some embodiments, multiple mapping tables are used instead of a single mapping table and the MAC address 1 is associated in a first table with HouseHold Identifier 1 (HH ID 1) and in a second table HH ID 1 is associated with an IP address (i.e., IP address 1). In such embodiments, a first search of the first table is performed based on the MAC address 1 to find the HH ID associated with the MAC address 1 which is HH ID 1 and then a second search is performed in which the HH ID 1 is used to search the second table which associated HH ID 1 with IP address 1. In some embodiments, other data storage methods other than tables are used such as linked list data records for the storing of the information on the association of the MAC address 1 with the IP address 1. Operation proceeds from step 28 to step 32.

In step 32, the VOD AD router 122 receives the message 30 from the customer data platform 126. Operation proceeds from step 32 to step 34.

In step 34, the VOD AD router 122 generates and transmits the AD Request message 36 to the Ad Server 124. The Ad request message 36 is generated based on the Ad opportunity message 18 and the message 30. The Ad request message 36 includes the IP address 1 associated with the MAC address 1 which was obtained from the customer data platform 126. In some embodiments, the information about the selected content which can be used in determining ad content is also included in the Ad request message 36. In some embodiments, the MAC address 1 and/or other information about the QAM device 1 with the MAC address 1 is included in the Ad request message 36 such as for example, device type, screen ratio, etc. The Ad request message 36 identifies at least one Ad opportunity from the one or more ad opportunities identified in the Ad opportunity message 18 to be included in the Ad request message 36. In some embodiments, the VOD AD router 122 determines which of the one or more Ad opportunities for the VOD stream requested in the QAM VOD request message 12 are to be filled via a programmatic advertising auction and which opportunities will be filled by ads from a programming partner/marketer of the cable network system 102 without a programmatic advertising auction (e.g., a programming partner/marketer or advertiser that has already agreed to purchase a number of ad opportunities and supplied the ad content to be presented such as a commercial for laundry detergent which is to presented 10 times a day with the particular ad opportunity selected by the cable network system operator within certain parameters agreed upon between cable network system operator and the programming partner/marketer). In some embodiments, when there are multiple ad opportunities to be filled with respect to the VOD stream to be provided in response to the QAM VOD request message 12 via programmatic advertising auctions, the VOD Ad router 122 generates a separate ad request message for each separate ad opportunity and communicates it to the Ad server 124. In some embodiments, each Ad request includes an Ad request number which is included in an Ad response provided in response to the Ad request. Operation proceeds from step 34 to step 38.

In step 38, the Ad server 124 receives the Ad request message 36 from the VOD AD router 122. Operation proceeds from step 38 to step 40.

In step 40, the Ad server 124 generates message 41 which is an Ad request with the IP address 1 and transmits the message 41 to the SSP 110. In some embodiments, the message 41 also includes other information included about the Ad request such as information about timing and length of the ad opportunity and/or ad opportunities, information about the device on which the ad content will play, the selected content which can be used in determining ad content (e.g., content identifier, information indicating it is for VOD, video title, audience rating (G, PG, PG-13, R, X, NR, mature audiences, children, teens, adults), video content type or category-children's programming, adult programming, educational programming (e.g., documentary about automobiles, politics, history), etc.) and/or information on the method of delivery of the ad content. For the sake of simplifying the example, the signaling diagram of FIG. 2 will be discussed as being for a single ad opportunity though multiple ad opportunities may be included in the Ad request message 41 and/or sent as separate Ad request messages from the Ad server 124 to the SSP 110 to be programmatically auctioned. In some embodiments, the Ad request message 41 is a real-time bid request including the IP address 1 (e.g., an IAB OpenRTB (ORTB) bid request with the IP address included in the device object of the ORTB request). The message 41 is based on the Ad request message 36. In some embodiments, the Ad request message with the IP Address 1 message 36 received from the VOD AD router 122 is forwarded as message 41. Operation proceeds from step 40 to step 42. The message 41 in most embodiments does not include the cable network operator's first party data for marketing targeting purposes (e.g., geo-location information of the QAM device 1 on which the ad will be displayed) as the marketer will be able to make marketing ad determinations based on the IP address information provided. In some embodiments, the message 41 does not include information about the VOD content such as video program title, audience rating but instead includes filtering information identifying rules or filters to be applied when matching ad bid requests with ad bid responses (e.g., when the Ad server 124 determines that the VOD program is directed at young children based on audience rating or the VOD program title an indication, rule or filter is included in the Ad request message 41 that the ad opportunity is not to be matched to a political ad or an ad with adult content (e.g., ad for violent movies or movies with R ratings, ad for pharmaceutical products, and/or ad for guns, etc.)). In some embodiments, information is included in the message 41 indicating that the bid request for the ad opportunity is not to be matched or sent to a black list of advertisers and/or is to be matched with or sent to a white list of advertisers. The use of matching rules and filtering allows the cable network operator to control who the bid request is sent to and/or matched with. In this way, the cable network operator can ensure that only ad content it deems appropriate is presented. In various embodiments, the message 41 includes specifications and/or requirements for the creative (i.e., ad content).

In step 42, the SSP 110 receives the message 41 and in some embodiments sends an acknowledgement of receipt of message 41 to Ad Server 124. Operation proceeds from step 42 to step 43. The message 41 in most embodiments does not include the cable network operator's first party data for marketing targeting purposes (e.g., geo-location information of the QAM device 1 on which the ad will be displayed) as the marketers (ad purchasers) will be able to make marketing ad determinations (e.g., geo-location targeting, frequency capping, addressable audience targeting) based on the IP address information provided.

In step 43, the SSP 110 generates bid request 44 based on message 41 (i.e., Ad request with IP address 1) and transmits it to the DSP 112. The bid request 44 includes the IP address 1. In some embodiments, the bid request 44 is a real-time bid request including the IP address 1 (e.g., an IAB OpenRTB (ORTB) bid request with the IP address included in the device object of the ORTB request). The bid request 44 may, and in some embodiments does, include information on one or more of the following: identification of publisher (i.e., the cable network operator), device information on the device to which the ad will be outputted (e.g., type of device (e.g., connected tv), device characteristics and/or attributes such as screen size, number of pixels, etc.), timing and duration of the ad opportunity, formatting information for the ad content, price floor for the ad opportunity, specification and/or requirements for the creative (e.g., ad content), filtering information. This information may, and in some embodiments is, provided with the Ad Request message 41. The DSP 112 receives the bid request 44 and in some embodiments sends an acknowledgement of receipt of bid request 44 to SSP 110. Upon receiving the bid request 44, the DSP 112 generates bid request messages to be sent to one or more of the Marketer Ad Server 1 114, Marketer Ad Server 2 116, . . . , Marketer Ad Server M 11 based on bid request message 44. Each of these bid request messages includes the IP address 1 and is based on the bid request message 44. In this example, bid request messages 47, 53 and 59 are generated and include the IP address 1. In some embodiments a single bid request message is generated (e.g., bid request message 47) which is sent to each of the Marketer Ad Servers served by the DSP 112. In some embodiments, the DSP 112 utilizes the bid request messages 44 for bid request messages 47, 53, and 59. The bid request messages 47, 53, and 59 in some embodiments are real time bid requests (e.g., an ORTB bid requests). The bid request messages 47, 53, and 59 may, and in some embodiments do, include information on one or more of the following: identification of publisher (i.e., the cable network operator), device information on the device to which the ad will be outputted (e.g., type of device (e.g., connected tv), device characteristics and/or attributes such as screen size, number of pixels, etc.), timing and duration of the ad opportunity, formatting information for the ad content, price floor for the ad opportunity, specification and/or requirements for the creative (e.g., ad content). Operation proceeds from step 45 in parallel to steps 46, 52, and 58.

In step 46, the bid request message 47 is transmitted to Marketer Ad Server 1 114. Operation proceeds from step 46 to step 48. In step 48, the bid request message 47 is received by the Marketer Ad Server 1 114 and in some embodiments an acknowledgement of receipt of the bid request message 47 is sent to the DSP 112. Operation proceeds from step 48 to step 49.

In step 49, the Marketer Ad Server 1 114 uses the IP address 1 included in the bid request message 47 to determine whether or not to generate a bid response in response to the received bid request. The Marketer Ad Server 1 114 also uses the IP address 1 for implementing ad targeting decisions including geo-location targeting decisions, frequency capping decisions, and addressable audience targeting decisions. The Marketer Ad Server 1 114 can determine what creative (i.e., ad content) to include in a bid response as well as price to bid based on information about the IP address 1 (e.g., IP address 1's geo-graphical location, the number of times the same creative (i.e., same ad) has been played to the IP address 1 in a time period, audience interest in a topic (e.g., websites visited by individuals using IP device 1 with IP address 1 such as for example a car dealership website indicates audience associated with IP address 1 are targets for car sale ads)). The information about the IP address may be generated by the Marketer Ad Server 1 114 from activity on the Marketer's or the Marketer's clients website or purchased/obtained by the Marketer from other sources. For example, if the Marketer is the Ford motor company, the Ford Motor Company can track the number of times IP address 1 has visited its website and what information was viewed by the user associated with IP address 1. Based on this information the Marketer Ad Server 1 114 can determine what creative (i.e., ad content) to include in the bid response. The information about IP address 1 can also be obtained from third party sources. The IP address 1 can be used to obtain geo-graphical information as to where the user is geo-graphically located. This information can be used in audience targeting campaigns based on geography such as ads for political candidates running for office in specific areas (e.g., a specific county or state election). Upon determining to make a bid response, the Marketer Ad Server 1 114 generates bid response 1 message 50 and transmits it to the DSP 112. The bid response 1 message 50 includes, among other things, a price and a link to a creative (i.e., ad creative). In some embodiments, the bid response also includes information identifying the advertiser when the Marketer Ad Server 1 114 represents multiple advertisers/clients. In some embodiments, the bid response is a real time bid response (e.g., an Open real time bid response). Operation proceeds from step 49 to step 51. In step 51, the DSP 112 receives the bid response 1 message 50 and in some embodiments sends an acknowledge message to Marketer Ad Server 1 114 acknowledging receipt of the bid response 1 message 50.

In step 52, bid request message 53 is transmitted to Marketer Ad Server 2 116. Operation proceeds from step 52 to step 54. In step 54, the bid request message 53 is received by the Marketer Ad Server 2 116 and in some embodiments an acknowledgement of receipt of the bid request message 53 is sent to the DSP 112. Operation proceeds from step 54 to step 55.

In step 55, the Marketer Ad Server 2 116 uses the IP address 1 included in the bid request message 53 to determine whether or not to generate a bid response in response to the received bid request. The Marketer Ad Server 2 116 also uses the IP address 1 for implementing ad targeting decisions including geo-location targeting decisions, frequency capping decisions, and addressable audience targeting decisions. The Marketer Ad Server 2 116 can determine what creative (i.e., ad content) to include in a bid response as well as a price to bid based on information about the IP address 1 (e.g., IP address 1's geo-graphical location, the number of times the same creative (i.e., same ad) has been played to the IP address 1 in a time period, audience interest in a topic). The information about the IP address may be generated by the Marketer Ad Server 2 116 from activity on the Marketer's or the Marketer's clients website or purchased/obtained by the Marketer from other sources as described in connection with Marketer Ad Server 1 above. Based on this information the Marketer Ad Server 2 116 can determine what creative (i.e., ad content) to include in the bid response. The information about IP address 1 can also be obtained from third party sources. The IP address 1 can be used to obtain geo-graphical information as to where the user is geo-graphically located. This information can be used in audience targeting campaigns based on geography such as described above in connection with the Marketer Ad Server 1 114. Upon determining to make a bid response, the Marketer Ad Server 2 116 generates bid response 2 message 56 and transmits it to the DSP 112. The bid response 2 message 56 includes, among other things, a price and information identifying content or media for the ad (e.g., a link to a creative (i.e., ad creative)). In some embodiments, the bid response also includes information identifying the advertiser when the Marketer Ad Server 2 116 represents multiple advertisers/clients. In some embodiments, the bid response is a real time bid response (e.g., an Open real time bid response). Operation proceeds from step 55 to step 57. In step 57, the DSP 112 receives the bid response 2 message 56 and in some embodiments sends an acknowledge message to Marketer Ad Server 2 116 acknowledging receipt of the bid response 2 message 56.

In step 58, bid request message 59 is transmitted to Marketer Ad Server M 118. Operation proceeds from step 58 to step 60. In step 60, the bid request message 59 is received by the Marketer Ad Server M and in some embodiments an acknowledgement of receipt of the bid request message 59 is sent to the DSP 112. Operation proceeds from step 60 to step 61.

In step 61, the Marketer Ad Server M 118 uses the IP address 1 included in the bid request message 59 to determine whether or not to generate a bid response in response to the received bid request. The Marketer Ad Server M 118 also uses the IP address 1 for implementing ad targeting decisions including geo-location targeting decisions, frequency capping decisions, and addressable audience targeting decisions. The Marketer Ad Server M 118 can determine what creative (i.e., ad content) to include in a bid response as well as a price to bid based on information about the IP address 1 (e.g., IP address 1's geo-graphical location, the number of times the same creative (i.e., same ad) has been played to the IP address 1 in a time period, audience interest in a topic). The information about the IP address may be generated by the Marketer Ad Server M 118 from activity on the Marketer's or the Marketer's clients website or purchased/obtained by the Marketer from other sources as described in connection with Marketer Ad Server 1 above. Based on this information the Marketer Ad Server M 118 can determine what creative (i.e., ad content) to include in the bid response. The information about IP address 1 can also be obtained from third party sources. The IP address 1 can be used to obtain geo-graphical information as to where the user is geo-graphically located. This information can be used in audience targeting campaigns based on geography such as described above in connection with the Marketer Ad Server 1 114. Upon determining to make a bid response, the Marketer Ad Server M 118 generates bid response M message 62 and transmits it to the DSP 112. The bid response M message 62 includes, among other things, a price and information identifying content for the ad (e.g., a link to a creative (i.e., ad creative)). In some embodiments, the bid response also includes information identifying the advertiser when the Marketer Ad Server M 118 represents multiple advertisers/clients. In some embodiments, the bid response is a real time bid response (e.g., an Open real time bid response). Operation proceeds from step 61 to step 63. In step 63, the DSP 112 receives the bid response M message 62 and in some embodiments sends an acknowledge message to Marketer Ad Server M 118 acknowledging receipt of the bid response M message 62.

While each of the Marketer Ad Servers 1 114, 2 116 and M 118 have responded to the ad opportunity bid requests, in some embodiments the decision of one or more of the Marketer Ad Server may be to forego a bid. In some embodiments, in which the Marketer Ad Server is servicing multiple advertisers/clients, a Marketer Ad Server may send several different bid responses with the different bid responses being for different advertisers/clients and having different terms (e.g., different bid price, information identifying different ad content or media to be presented (e.g., link to different creative), different advertiser identifier).

Operation proceeds from steps 51, 57 and 63 to step 64. In step 64, the DSP 110 transmits the bid responses 50, 56 and 62 to the SSP 110. In some embodiments, the bid responses 50, 56 and 62 are transmitted individually as they are received by the DSP 112 from the Marketer Ad Servers. In some embodiments, after a first time period has expired all bid responses received are transmitted together in a bid response message 65 which is generated by the DSP 112 from the bid responses received in the first time period. Operation proceeds from step 64 to step 66.

In step 66, the SSP 110 receives the bid responses 50, 56 and 62 from the DSP 112 either as individual messages or in bid response message 65 which includes each of the separate bid responses 50, 56 and 62. The SSP 110 implements a bid request and bid response matching algorithm in which a matching criteria are used to determine the winning bid response for the bid request 44 from the bid responses 50, 56 and 62. In some embodiments, the matching criteria is that the highest priced bid response is chosen as the winning bid response. In some embodiments, the matching criteria includes a weighted set of factors that are used to determine the winning bid response. The weights indicating the importance of the factor. The factors can include the bid response price must be above a bid price floor, the highest bid price above the bid price floor, the advertiser is not on a blacklist (e.g., advertisers which are competitors of the cable network operator, advertisers which the cable network operator does not wish to be associated, advertisers which have outstanding ad payment amounts above a threshold amount with the cable network operator, etc.), the content of the ad or creative has an audience rating (e.g., G, PG, PG-13, R, X) equal to or below the rating of the selected video on demand content, content of the ad or creative does not meet a filtering rule to be applied (e.g., no political ads for VOD content of children's movies). Frequency capping may also be applied as part determining the winning bid response (e.g., capping the number of times the same ad or an ad from the same advertiser is displayed to the same IP address in a fixed amount of time). In some embodiments, upon the SSP 110 determining the winning bid response from the bid responses 50, 56 and 62, a message is generated by the SSP 110 and communicated via the DSP 112 to the Marketer Ad Server which placed the bid response selected as the winning bid response. This message includes information informing the Marketer Ad Server that its bid response won. Operation proceeds from step 66 to step 67.

In step 67, the SSP 110 generates winning bid response message 68 and transmits it to the Ad Server 124 in response to the Ad request message 41. The winning bid response message 68 is based on the winning bid response determined in step 66. In some embodiments, the winning bid response message 68 includes the winning bid response as well as additional information such as for example a transaction identifier. The winning bid response message 68 includes information identifying the content to be supplied to the QAM device 1 130 as part of the VOD QAM session. In some embodiments, the information identifying the content to be supplied to the QAM device 1 130 is a link to the ad content or creative for the ad impression. Operation proceeds from step 67 to step 69.

In step 69, the AD server 124 receives the winning bid response message 69 from the SSP 110. The winning bid response message 68 as previously discussed includes information identifying content to be supplied to the QAM 1 device 130 such as a link to an advertisement, media content, or creative for an impression corresponding to the winning bid response. Operation proceeds from step 69 to step 70.

In step 70, the ad server 124 initiates delivery of the identified content in the winning bid response message 68 via the requested VOD QAM session to the QAM device 1 130 located at the first customer premises. This includes generating, by the Ad server 124, message 71 and transmitting message 71 to VOD Ad router 122 in response to the Ad Request message 24. The message 71 includes information identifying the content (e.g., Ad content or creative) identified in the winning bid response message 68 (e.g., a link to content in an ad content server of the advertiser who had the winning bid response). The message 71 in some embodiments includes instructions which command the VOD Ad router 122 to provide the identified content (e.g., the ad or creative) to the content server 121 (e.g., a VOD QAM content server) for insertion into the QAM VOD content stream requested by the QAM device 1 130 with MAC address 1. Operation proceeds from step 70 to step 72.

In step 72, the VOD Ad router 122 receives the message 71 from the Ad Server 124. Operation proceeds from step 72 to step 74.

In step 74, the VOD Ad router 122, obtains the content (e.g., ad content or creative) identified in message 71 to be supplied to the QAM device 1 130 and determines whether or not content (e.g., ad content or creative) meets the specifications and/or requirements included in the Ad Request 41. Upon determining that the identified content meets the specifications and/or requirements (e.g., length of time for ad display, image quality, etc.), communicates the content to the content server 121 via messaging 76. In some embodiments, in step 74, the VOD Ad router 122 implements instructions included in the message 71. In some embodiments, the VOD Ad router 122 performs format conversions on the identified content placing the content in a format for transmission as a QAM signal. Messaging 76 includes instructions for the content server 121 to insert the identified content into the QAM VOD stream requested by the QAM device 1 130 with MAC address 1 in QAM VOD request message 12. Operation proceeds from step 74 to step 77.

In step 77, the content server 121 receives the messaging 76. Operation proceeds from step 77 to step 78.

In step 78, the content server 121 generates and transmits QAM signals 79 including the identified content (e.g., ad content or creative) to the QAM device 1 130 located at the customer premises 1 104. The QAM signals for the identified content being inserted into the QAM VOD session requested by the QAM device 1 130 in step 11 via message 12. In some embodiments, the identified content may be inserted prior to the start of the QAM VOD content stream including the requested VOD content while in other cases it may be inserted after beginning of the start of the QAM VOD content stream. The content server 121 implements instructions provided in received messages 76 regarding the identified content. Operation proceeds from step 78 to step 80.

In step 80, the QAM device 130 receives the identified content (e.g., ad content or creative) in QAM signals 79. Operation proceeds from step 80 to step 81.

In step 81, the QAM device 1 130 generates signals 82 including the content (i.e., ad content or creative identified in the winning bid response) received in step 80 and outputs or transmits the generated signals 82 to the display device 1 128. The generation of the signals 82 may be, and in some embodiments does, include the demodulation of the QAM signals. Operation proceeds from step 81 to step 83.

In step 83, the display device 1 128 (e.g., a television set) receives the signals of the identified content (i.e., the ad content or creative) and outputs the signals as video images and/or audio via a display screen and speakers. The ad content identified in the winning bid response is thus supplied to the user and/or users of the QAM device 1 130 in accordance with the agreement reached between the cable network operator and the advertiser who provided the winning bid response in response to the bid request 44 when the SSP 110 determined the winning bid response.

While the identified content supplied to the QAM device 1 130 has been described as ad content, this is only exemplary and other types of content are applicable and may be used in place of advertisements in the method 200, e.g., media content which makes a service announcement may be, and in some embodiments, may be the identified content. The ad opportunity or ad space in such circumstances is space or time available for presentation of content by other content suppliers than the cable network system operator.

In various embodiments, the IP address included in the bid request is a public IPv4 or public IPv6 address.

While the method 200 has been illustrated in connection with exemplary system 100 which includes a single SSP and a signal DSP, the system is scalable and can be implemented with multiple SSP and multiple DSP. For example, when there are multiple DSP, the SSP will transmit the bid request with IP address message 44 to one or more DSPs and receive bid responses from the one or more DSPs with each of the DSPs sending the bid request out to one or more Marketer Ad Servers. Similarly, systems with multiple SSP can be implemented which share information on the bid responses and then determine the winning bid response based on the shared information. In other systems with the multiple SSP, an SSP hierarchy may be used in which a master SSP receives a best bid response match from each of a set of slave SSPs and determines the winning bid response from the best bid responses received from each of the set of slave SSPs.

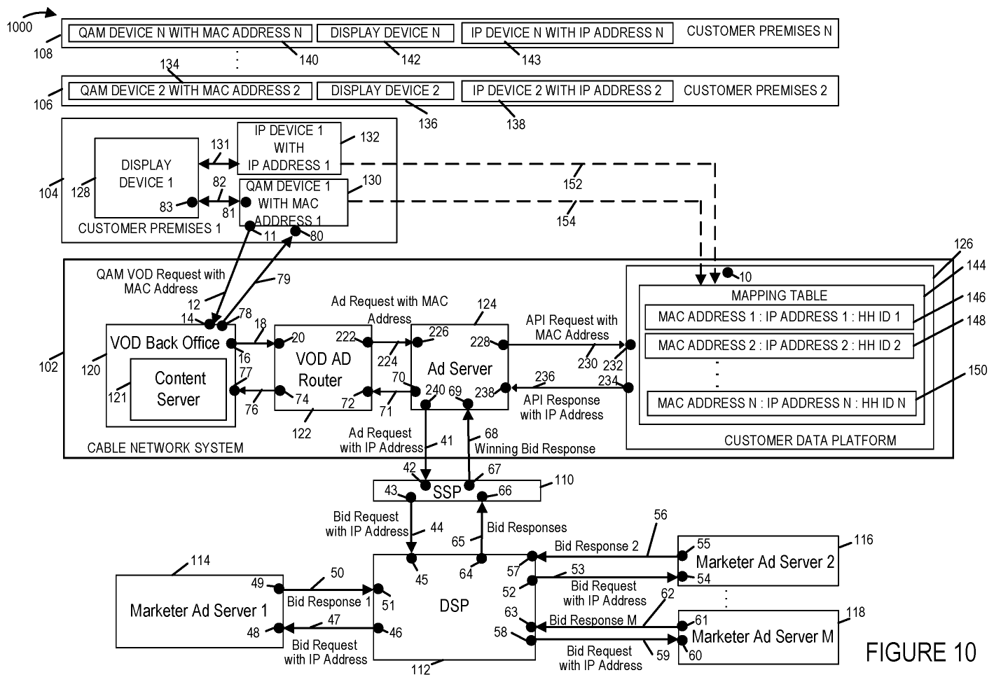

FIG. 10 illustrates another signaling diagram which illustrates the steps and signaling of another exemplary method 1000 in accordance with an embodiment of the present invention.

While it will be readily understood that additional steps and signaling are performed in connection with communicating information, messages, and packets between devices, the method 1000 focuses on and discusses the steps and signaling for understanding the invention. The exemplary signaling diagram/method 1000 is implemented on exemplary system 100 with only those elements of the system 100 necessary for understanding the invention being shown in FIG. 10. For example, the communications links on which the signals/messages are communicated between devices is not illustrated. The signaling diagram/method 1000 may be, and in some embodiments is, implemented using other systems other than system 100 and/or other system architectures. Elements or steps with the same reference numbers used in different figures are the same or similar and those elements or steps will not be described in detail again. The signaling flow and method 1000 is similar to the signaling flow and method 200 illustrated in FIG. 2 and discussed above with the exception of the elements, steps and signaling flow related to the cable network system's generation of the Ad request message which includes the IP address 1 which is associated with QAM device 1 MAC address 1 illustrated in steps 22, 26, 28, 32, 34, and 40 of method 200 and messages 24, 30 and 36 of method 200. These steps and messages of method 200 have been replaced by steps 222, 226, 228, 232, 234, 238, and 240 and messages 224, 230, and 236 of method 1000 which will now be described.

The method 1000 starts in start step 10 as described in connection with the method 200 above. From step 10 the method 1000 proceeds as discussed in connection with method 200 above until step 20.

In step 20, the VOD Ad router 122 receives the Ad opportunity message 18. Operation proceeds from step 20 to step 222. In step 222, the VOD Ad router 122 generates and transmits Ad request message 224 to the Ad server 124. The Ad request message 224 is generated based on the Ad opportunity message 18. The Ad request message 24 includes the MAC address 1 and in some embodiment the information about the selected content (i.e., the selected VOD content requested) which can be used in determining ad content and/or information about the QAM device 1 with MAC address 1. Operation proceeds from step 222 to step 226.

In step 226, the Ad server 124 receives the AD request message 224 from the VOD Ad router 122. In some embodiments, the Ad server 124 determines that the Ad request 224 is for a QAM VOD session (e.g., based on one or more of the following: the MAC Address included in the AD request message 224, information (e.g., a QAM device indicator) included in the Ad request message 224, and/or that the ad request 24 was received from the VOD Ad router 122). Operation proceeds from step 226 to step 228.

In step 228, the Ad server 124 generates and transmits message 230 to the customer data platform 126. The message 230 in some embodiments includes or is based on the Ad request message 224. The message 230 includes the MAC address 1. In some embodiments, the message 30 is a query message including the MAC address 1 of the QAM device 1 130 requesting an IP address which is associated with the MAC address 1. In some embodiments, the message 230 is an API request with the MAC address 1 requesting the customer data platform 126 provide an IP address associated with and/or paired with the MAC address 1. Operation proceeds from step 228 to step 232.

In step 232, the customer data platform 126 receives the message 230. Operation proceeds from step 232 to step 234.

In step 234, the customer data platform 126 performs a query or search of information stored in the Customer Data Platform 126 based on and/or using the MAC address included in the message 230 (i.e., MAC address 1) for an IP address associated with the MAC address included in the message 230. In this example, the Customer Data Platform 126 performs a search of the mapping table 144 based on the MAC Address 1 and determines from the table entry 146 that IP address 1 is associated with MAC address 1. Upon identifying and retrieving MAC address 1 from the mapping table 144 entry 146, the customer data platform 126 generates message 236 and transmits message 236 to Ad server 124 in response to the received message 230. The message 236 includes the IP address 1 which was associated with the MAC address 1 in the mapping table 144. In some embodiments in which the message 230 is an API request message with the MAC address 1, the message 236 is the API response message 230 including the IP address 1. In some embodiments, the mapping table 144 is included in a storage device, e.g., a database server system, separate from but connected and/or coupled to the customer data platform 126. In such embodiments, the customer data platform 126 performs the step of querying the storage device for an IP address which is associated with the MAC address 1. In some embodiments, multiple mapping tables are used instead of a single mapping table and the MAC address 1 is associated in a first table with HouseHold ID 1 (HH ID 1) and in a second table HH ID 1 is associated with an IP address (i.e., IP address 1). In such embodiments, a first search of the first table is performed based on the MAC address 1 to find the HH ID associated with the MAC address 1 which is HH ID 1 and then a second search is performed in which the HH ID 1 is used to search the second table which associated HH ID 1 with IP address 1. In some embodiments, other data storage methods other than tables are used such as linked list data records for storing the information on the association of the MAC address 1 with the IP address 1. Operation proceeds from step 234 to step 238.

In step 238, the Ad server 124 receives the message 236 from the customer data platform 126. Operation proceeds from step 238 to step 240. In step 240, the Ad Server 124 generates the Ad Request message 41 with the IP address received from the customer data platform and information received in message 224 (e.g., information about the Ad opportunity as previously described in connection with the method 200). The remaining steps of the method 1000 are the same as method 200 discussed above.

While the method 1000 illustrates an alternative embodiment of the invention in which the Ad Server 124 of the cable network system 102 obtains the IP address associated with the MAC address from the customer data platform for use in generating an Ad request, it should be understood that other cable network equipment devices in the cable network system 102 can also be used to implement embodiments of the invention by obtaining from a storage device of the cable network system an IP address of an IP device associated with a MAC address of QAM device co-located at the same customer premises. For example, equipment in VOD Back Office 120 (e.g., content server 121) which generates message 18 can perform a query of the customer data platform 126 using the MAC address received in the QAM VOD Request 12 and obtain the IP address 1 of the IP device 1 located at customer premises 1 and associated in the customer data platform with the MAC address 1 included in the QAM VOD Request message 12. The message 18 which includes information for one or more opportunities for presentation of an ad in such embodiments can then also include the IP address 1. In such a case, the VOD Ad Router 122 and/or Ad Server 124 do not need to perform any query of the customer data platform to generate an Ad request for the QAM device 1 as the IP address is provided along with information on the opportunities for one or more ads to the VOD Ad Router 122.

Messages and/or signals discussed in the methods 200 and 1000 as being transmitted between entities may be shared and/or communicated instead of transmitted.

The methods 200 and 1000 are typically implemented as real time or near real time auctions with the bidding for individual items (e.g., ad space or opportunities for presenting content) occurring in real-time or near real-time. While in the present examples, the SSP 110 implements the role of auctioneer and determines the winning bid in some embodiments the DSP 112 implements the role of auctioneer and makes the determination of the winning bid. In some other embodiments, an external exchange platform separate from the SSP 110 and DSP 112 may act as the auctioneer and receive bid requests from the SSP 110 and bid responses from the DSP 112 and make the determination of the winning bid response.

The methods 200 and 1000 overcome the past problems of limited targetability of QAM devices in programmatic ecosystems. Furthermore, the methods 200 and 1000 do not require the cable network operator to manage all targeting through ad server driven executions leveraging the operator's first party data. Furthermore, the first party audience data from marketers need not be transmitted to or shared with operators (cable network operators, SSP operators or DSP operators) to execute targeting for specific ad campaigns which can be time-consuming, costly and require the exposure of marketer's first-party data. The methods 200 and 1000 enable marketers to retain their first-party data in a privacy compliant manner, expedite the ease and timeliness of execution, and eliminate the need for costly data sharing integrations that create burdens for both marketers and operators. Moreover, the methods 200 and 1000 allow marketers to implement ad frequency capping on a per household basis using the IP address included in the bid request which was not previously possible for QAM devices. This further offloads processing from the cable network operator which previously was tasked with this ad frequency capping activity as it contained the information as to which ads had been supplied to which QAM devices in a time period. This is a further cost reduction and is more efficient for the cable network operator.

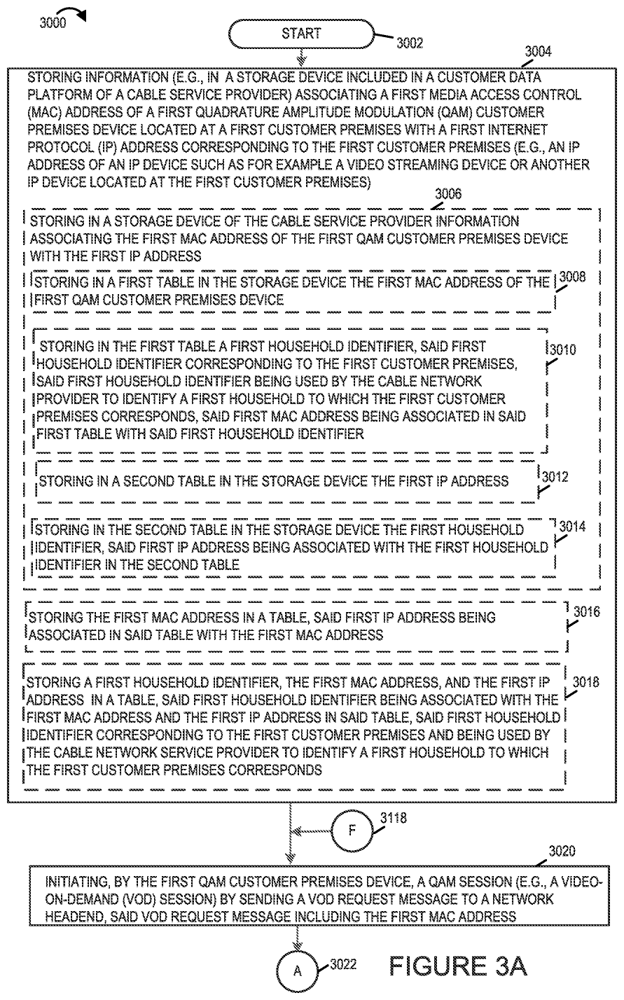

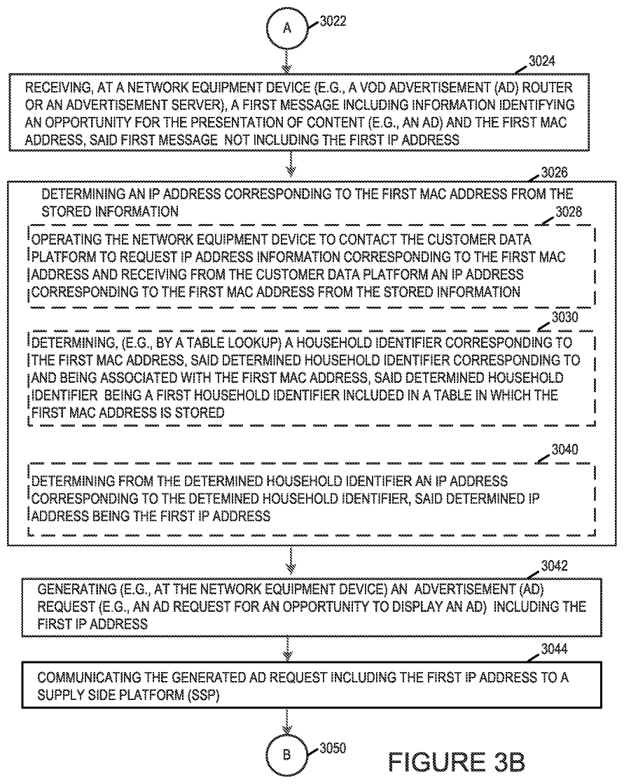

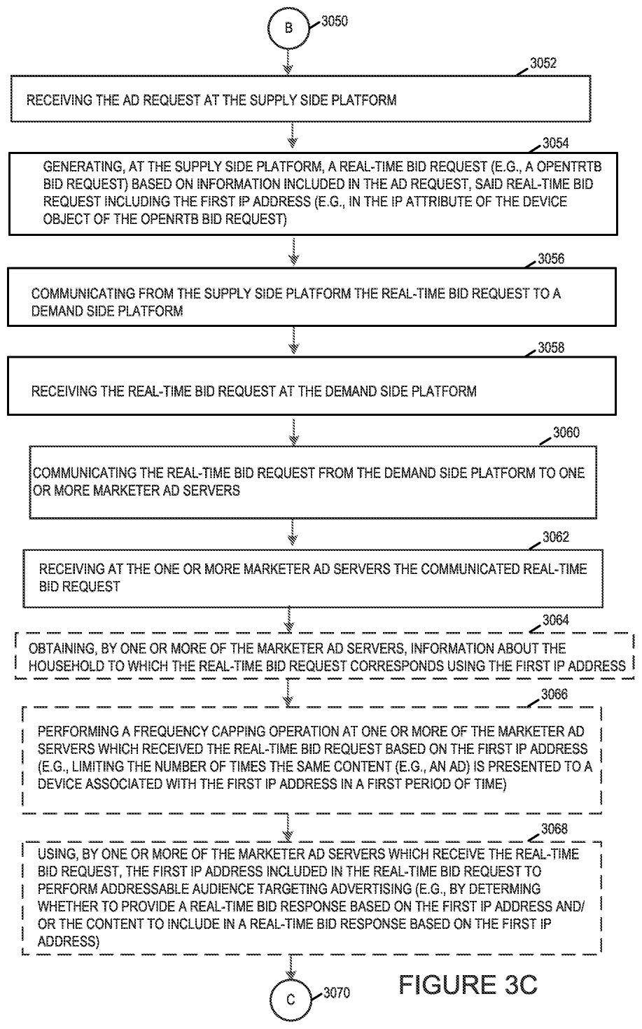

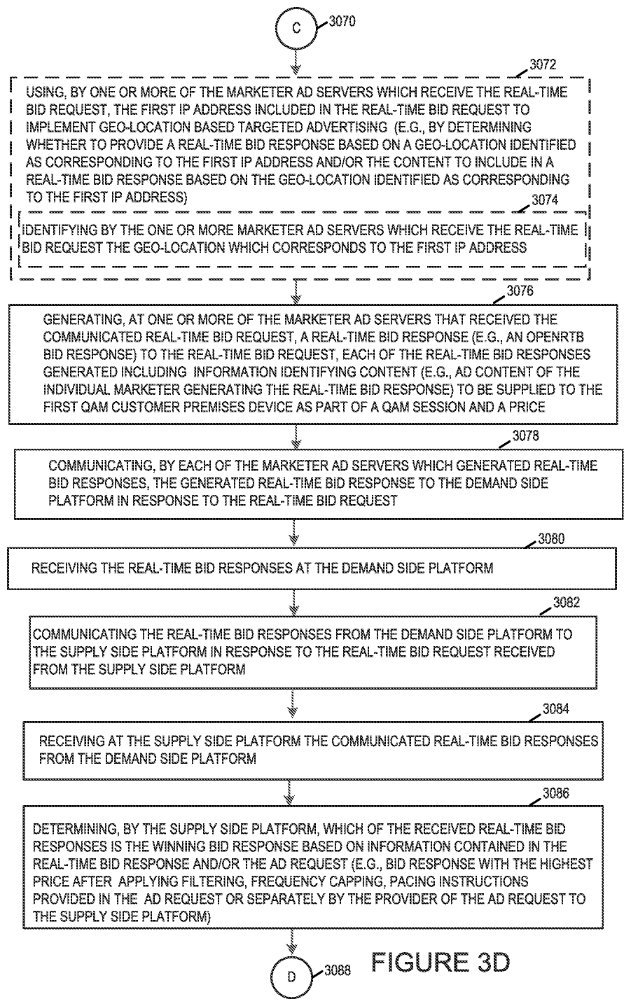

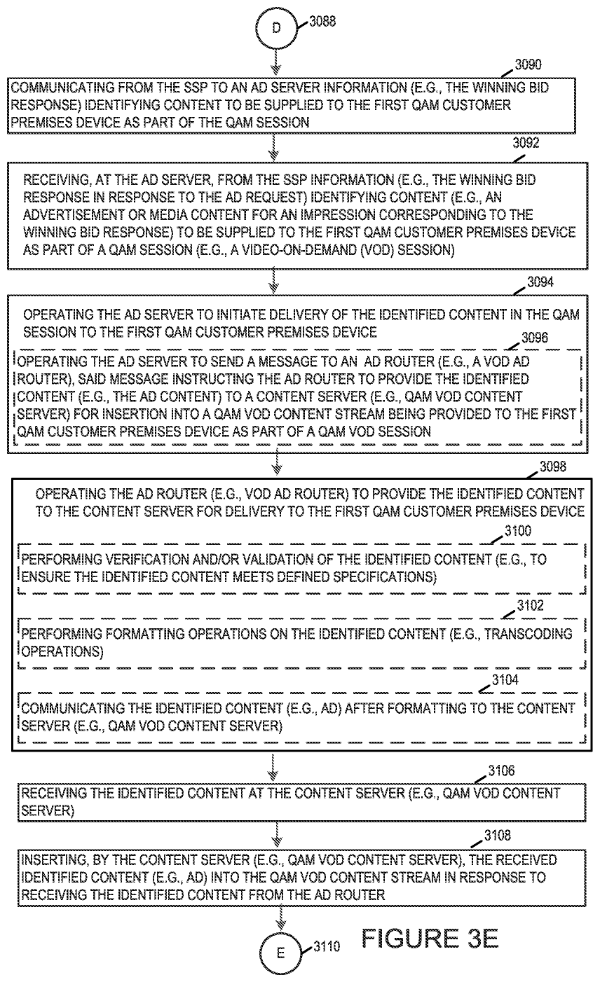

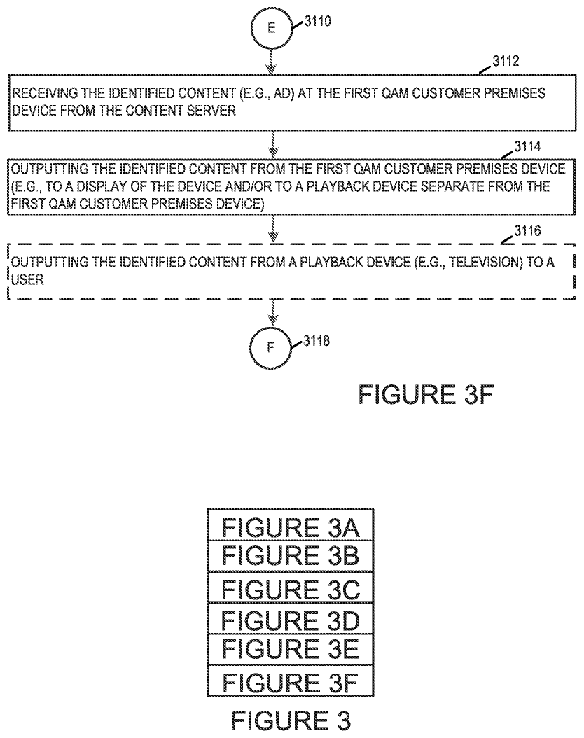

FIG. 3 illustrates a flowchart of the steps of an exemplary method 3000 in accordance with an embodiment of the present invention. FIG. 3 comprises FIG. 3A, FIG. 3B, FIG. 3C, FIG. 3D, FIG. 3E, and FIG. 3F. FIG. 3A is the first part of a flowchart of an exemplary method 3000 in accordance with an embodiment of the present invention. FIG. 3B is the second part of a flowchart of an exemplary method 3000 in accordance with an embodiment of the present invention. FIG. 3C is the third part of a flowchart of an exemplary method 3000 in accordance with an embodiment of the present invention. FIG. 3D is the fourth part of a flowchart of an exemplary method 3000 in accordance with an embodiment of the present invention. FIG. 3E is the fifth part of a flowchart of an exemplary method 3000 in accordance with an embodiment of the present invention. FIG. 3F is the sixth part of a flowchart of an exemplary method 3000 in accordance with an embodiment of the present invention.

While it will be readily understood that additional steps and are performed in connection with communicating information, messages, requests, responses and packets between devices, the method 3000 focuses on and discusses the steps for understanding the invention. The exemplary method 3000 may be, and in some embodiments is, implemented on exemplary system 100 illustrated in FIG. 1. The method 3000 may be, and in some embodiments is, implemented using other systems other than system 100 and/or other system architectures.

The method 3000 starts in step 3002 shown on FIG. 3A. Operation proceeds from start step 3002 to step 3004.

In step 3004, information associating a first media access control (MAC) address (e.g., MAC address 1) of a first Quadrature Amplitude Modulation (QAM) customer premises device (e.g., QAM device 1 130 of system 100) located at a first customer premises (e.g., customer premises 104 of system 100) with a first Internet Protocol (IP) address (e.g., IP address 1) corresponding to the first customer premises (e.g., an IP address of an IP device (e.g., IP device 1 132 of system 100) such as for example a video streaming device or another IP device located at the first customer premises) is stored in a data storage device (e.g., a data storage device included in or attached to a customer data platform (e.g., customer data platform 126 of system 100) of a cable service provider). In some embodiments, step 3004 includes one or more sub-step 3006, 3016 and 3018.

In sub-step 3006, information associating the first MAC address of the first QAM customer premises device with the first IP address is stored in a storage device of the cable service provider. In some embodiments, sub-step 3006 includes one or more sub-steps 3008, 3010, 3012, 3014. In sub-step 3008, the first MAC address of the first QAM customer premises device is stored in a first table of the storage device. In sub-step 3010, a first household (HH) identifier (e.g., HH ID 1) is stored in the first table. The first household identifier corresponds to first customer premises and is used by the cable network provider to identify a first household to which the first customer premises corresponds. The first MAC address is associated in the first table with the first household identifier. In sub-step 3012, the first IP address is stored in a second table in the storage device. In sub-step 3014, the first household identifier is stored in the second in the storage device. The first IP address is associated with the first household identifier in the second table.

In sub-step 3016, the first MAC address is stored in a table, the first IP address being associated in the table with the first MAC address.

In sub-step 3018, a first household identifier, the first MAC address, and the first IP address are stored in a table. The first household identifier is associated in the table with the first MAC address and the first IP address. The first household identifier corresponds to the first customer premises and is used by the cable network service provider to identify a first household to which the first customer premises corresponds. Operation proceeds from step 3004 to step 3020.

In step 3020, the first QAM customer premises device initiates a QAM session (e.g., a unicast QAM session such as a Video-on-Demand (VOD) session) by sending a QAM session request (e.g., a VOD QAM session request message) to a network headend (e.g., to equipment in the headend). the QAM session request (e.g., VOD session request message) including the first MAC address. Operation proceeds from step 3020 via connection node A 3022 to step 3024 shown on FIG. 3B.

In step 3024, a network equipment device (e.g., VOD AD router 122 of system 100 or AD Server 124 of system 100) receives a first message including information identifying an opportunity for the presentation of content (e.g., an ad) and the first MAC address. The first message does not include the first IP address. In some embodiments, the network equipment device is a VOD AD router which receives the first message from a device (e.g., a content server) in a VOD back office (e.g., VOD back office 120 of system 100). In some embodiments, the network equipment device is an Ad Server. In some such embodiments, the first message received by the Ad server is an ad request message including the first MAC address which is received from an Ad router (e.g., Ad router 122) as a result of or in response to the QAM request from the first QAM customer premises device. Operation proceeds from step 3024 to step 3026.

In step 3026, an IP address corresponding to the first MAC address is determined from the stored information. Step 3026 in some embodiment includes one or more sub-steps 3028, 3030, and 3040.

In sub-step 3028, the network equipment device (e.g., the Ad router or the Ad Server) contacts a customer data platform (e.g., customer data platform 126) to request IP address information corresponding to or associated with the first MAC address and the network equipment device receives from the customer data platform an IP address corresponding to or associated with the first MAC address from the stored information. The IP address received being the first IP address.

In sub-step 3030, a household identifier corresponding to the first MAC address is determined (e.g., by a table lookup). The determined household identifier corresponds to the and is associated with the first MAC address. The determined household identifier is a first household identifier included in a table in which the first MAC address is stored. The determined household identifier is the first household identifier (e.g., HH ID 1). In sub-step 3040, an IP address corresponding to and/or associated with the determined household identifier is determined from the determined household identifier (e.g., HH ID 1). The determined IP address being the first IP address. Operation proceeds from step 3026 to step 3042.

In step 3042, an advertisement (ad) request (e.g., an ad request for an opportunity to display an ad) including the first IP address is generated (e.g., at the network equipment device) based on the first message. In some embodiments, when the network equipment device is an ad server and the first message is an ad request message with the first MAC address but not the first IP address, the first message is modified to include the first IP address as part of generating the ad request with the first IP address. Operation proceeds from step 3042 to step 3044.

In step 3044, the generated ad request including the first IP address is communicated (e.g., from the network equipment device) to a Supply Side Platform (SSP) (e.g., SSP 110 of system 100). When the network equipment device is an ad router, the generated ad request is typically communicated to the SSP via an Ad server. The Ad server may, and in some instances does, modify the ad request (e.g., by re-formatting the Ad request and/or modifying the contents of the Ad request) before forwarding the Ad request to the SSP. The re-formatting may be done or needed for purposes of communicating with the SSP for example if ad requests are communicated from the cable network system Ad server to the SSP using an Application Programming Interface which has formatting different than that provided in the ad request received by the Ad server from the Ad router. In some embodiments, the Ad server may also have other requirements or information that is to be communicated to the SSP with respect to the SSP's handling of the ad request (e.g., filtering information, publisher information, white list information, black list information, pricing information, etc. which has not been included in the ad request as received from the ad router). Operation proceeds from step 3044 to step 3052 shown on FIG. 3C via connection node B 3050.

In step 3052, the ad request is received at the supply side platform. Operation proceeds from step 3052 to step 3054.

In step 3054, a real-time bid request (e.g., an IAB OpenRTB bid request) is generated at the supply side platform based on information included in the ad request. The real-time bid request includes the first IP address (e.g., in the IP attribute of the device object of the OpenRTB bid request). Operation proceeds from step 3054 to step 3056.

In step 3056, the real-time bid request is communicated from the supply side platform to a demand side platform (DSP) (e.g., DSP 112 of system 100). Operation proceeds from step 3056 to step 3058.

In step 3058, the real-time bid request is received at the demand side platform. Operation proceeds from step 3058 to step 3060.

In step 3060, the real-time bid request is communicated from the demand side platform to one or more marketer ad servers (e.g., Marketer Ad servers 1 114, 2 116, . . . , N 118 of system 100). Operation proceeds from step 3060 to step 3062.

In step 3062, one or more of the marketer ad servers to which the real-time bid request was sent receive the real-time bid request. Operation proceeds from step 3062 to step 3064. In some embodiments, step 3064 is optional and can be skipped or bypassed.

In step 3064, one or more of the marketer ad servers which received the real-time bid request obtain information about the household to which the real-time bid request corresponds using the first IP address. In some embodiments, one or more of the marketer ad servers perform a database lookup or search using the first IP address to retrieve first party marketer information corresponding to the first IP address. In some such embodiments, the database and the information contained therein is proprietary to the marketer performing the lookup or search. Operation proceeds from step 3064 to step 3066. In some embodiments, step 3066 is optional and can be skipped or bypassed.

In step 3066, a frequency capping operation is performed at one or more of the marketer ad servers which received the real-time bid request based on the first IP address (e.g., by limiting the number of times the same content (e.g., the same ad) is presented to a device associated with the first IP address for a given period of time (i.e., a first time period) such as for example by refraining from sending a bid response to the bid request that includes the same ad content when the limit for the ad has been reached in the given time period (e.g., 60 minutes)). Operation proceeds from step 3066 to step 3068.

In step 3068, one or more of the marketer ad servers which receive the real-time bid request use the first IP address included in the real-time bid request to perform addressable audience targeting advertising (e.g., by determining whether to provide a real-time bid response to the real-time bid request based on the first IP address and/or determining the content to include in a real-time bid response based on the first IP address). Operation proceeds from step 3068 to step 3072 shown on FIG. 3D via connection node C 3070. Step 3072 is optional and in some embodiments is skipped or bypassed.

In step 3072, one or more of the marketer ad servers which receive the real-time bid request use the first IP address included in the real-time bid request to implement geo-location based targeted advertising (e.g., by determining whether to provide a real-time bid response based on a geo-location identified as corresponding to the first IP address and/or determining the content to include in a real-time bid response based on the geo-location identified as corresponding to the first IP address). In some embodiments, step 3072 includes sub-step 3074. In sub-step 3074, the one or more of the marketer ad servers which receive the real-time bid request identify a geo-location corresponding to the first IP address. Operation proceeds from step 3072 to step 3076.

In step 3076, a real-time bid response (e.g., an OpenRTB response) is generated in response to the real-time bid request at the one or more of the marketer ad servers that received the communicated real-time bid request. Each of the real-time bid responses including information identifying content (e.g., ad content of the individual marketer generating the real-time bid response) to be supplied to the first QAM customer premises device as part of a QAM session and a price. Operation proceeds from step 3076 to step 3078.

In step 3078, each of the marketer ad servers which generated a real-time bid response communicate the generated real-time bid response to the demand side platform in response to the real-time bid request. Operation proceeds from step 3078 to step 3080.

In step 3080, the real-time bid responses are received at the demand side platform. Operation proceeds from step 3080 to step 3082.

In step 3082, the real-time bid responses are communicated from the demand side platform to the supply side platform in response to the real-time bid request received from the supply side platform. In some embodiments, the demand side platform may filter out some of the real-time bid response for example by using the IP address information to implement frequency capping and/or pacing of ads such as for example from the same marketer ad server or related to a specific ad campaign. The filtered out real-time bid responses are then not communicated to the supply side platform. Operation proceeds from step 3082 to step 3084.

In step 3084, the supply side platform receives the communicated real-time bid responses from the demand side platform. Operation proceeds from step 3084 to step 3086.

In step 3086, the supply side platform determines which of the received real-time bid responses is the winning bid response based on information contained in the real-time bid response and/or the ad request (e.g., selecting the bid response with the highest price after applying filtering, frequency capping, packing instructions provided in the ad request or separately by the provider of the ad request to supply side platform). Operation proceeds from step 3086 to step 3090 shown on FIG. 3E via connection node D 3088.

In step 3090, the supply side platform communicates to the Ad Server information (e.g., the winning bid response) identifying content to be supplied to the first QAM customer premises device as part of the QAM session. Operation proceeds from step 3090 to step 3092.

In step 3092, the information (e.g., the winning bid response in response to the Ad request) identifying content (e.g., an advertisement or media content for an impression corresponding to the winning bid response) to be supplied to the first QAM customer premises device as part of a QAM session (e.g., a video-on-demand (VOD) session) is received at the Ad server. Operation proceeds from step 3092 to step 3094.

In step 3094, the Ad Server is operated to initiate delivery of the identified content (e.g., ad) in the QAM session to the first QAM customer premises device. In some embodiments, step 3094 includes sub-step 3096. In sub-step 3096, the Ad Server is operated to send a message to an Ad Router (e.g., a VOD Ad Router) instructing the Ad Router to provide the identified content (e.g., the ad content) to a content server (e.g., QAM VOD content server) for insertion into a QAM VOD content stream being provided to the first QAM customer premises device as part of a QAM VOD session. Operation proceeds from step 3094 to step 3098.

In step 3098, the Ad router (e.g., VOD Ad router 122 of system 100) is operated to provide the identified content (e.g., ad) to the content server for delivery to the first QAM customer premises device. In some embodiments step 3098 includes one or more sub-steps 3100, 3102, and 3106. In sub-step 3100, the Ad router performs verification and/or validation of the identified content (e.g., to ensure the identified content meets defined specifications). In sub-step 3102, the Ad server performs formatting operations on the identified content (e.g., transcoding operations). In sub-step 3104, the Ad server communicates the identified content (e.g., ad) after formatting to the content server (e.g., QAM VOD content server). Operations proceed from step 3098 to step 3106.

In step 3106, the identified content is received at the content server (e.g., QAM VOD content server). Operation proceeds from step 3106 to step 3108.

In step 3108, the content server (e.g., QAM VOD content server) inserts the identified content (e.g., ad) into the QAM VOD content stream of a QAM session in response to receiving the identified content from the Ad router. Operation proceeds from step 3108 to step 3112 shown on FIG. 3F via connection node E 3110.

In step 3112, the identified content (e.g., ad) is received at the first QAM customer premises device from the content server. Operation proceeds from step 3112 to step 3114.

In step 3114, the identified content (e.g., ad) is outputted from the first QAM customer premises device (e.g., to a display of the first QAM customer premises device or to a playback device (e.g., a television) separate from the first QAM customer premises device). Operation proceeds from step 3114 to step 3116. In some embodiments, step 3114 is optional and can be skipped or bypassed such as when the identified content is outputted directly from the first QAM customer premises device to the user and not to a separate playback device.

In step 3116, the identified content is outputted from a playback device (e.g., a television) to a user. Operation proceeds from step 3116 via connection node F 3118 to step 3020 shown on FIG. 3A where the method is repeated in connection with the initiation of another QAM session (e.g., QAM VOD session) by the first QAM customer premises device.

While the method has been illustrated with respect to a single QAM customer premises device located at the first customer premises, the method may be, and typically is, used for a plurality of QAM customer premises devices whose MAC addresses are associated with IP addresses of co-located IP devices such as illustrated in system 100. Furthermore, while the method 3000 has been explained in terms of real-time bid requests and real-time bid responses, the method is also applicable to non-real time bid requests and non-real time bid responses which are used for selling ad space or ad opportunities for example in anticipation of an ad opportunity becoming available.

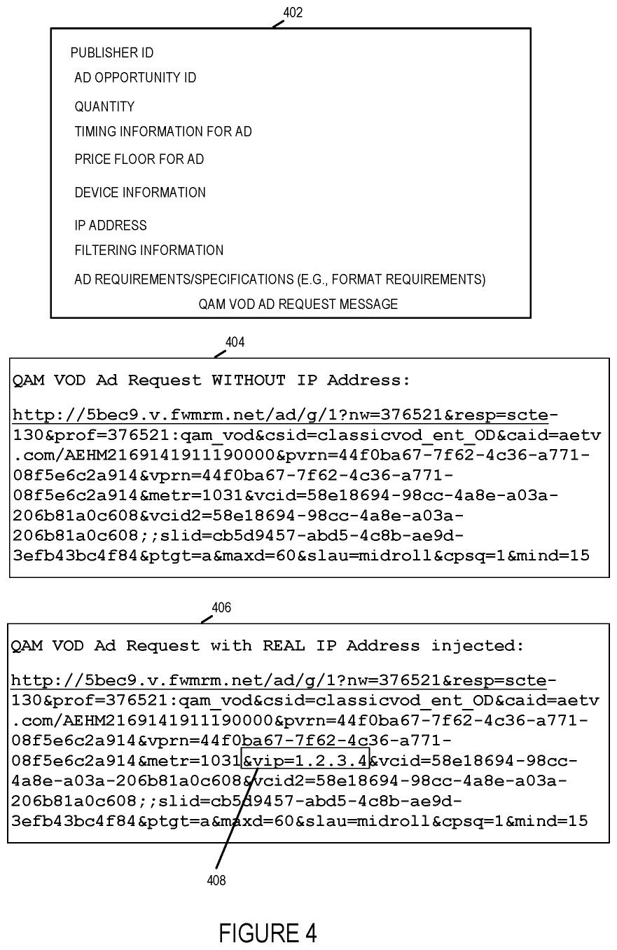

FIG. 4 illustrates a plurality of different QAM VOD Ad request messages 402, 404, and 406 which may be sent from an Ad Server (e.g., 124 of system 100) to a SSP (e.g., SSP 110 of system 100).

The QAM VOD Ad request message 402 is an exemplary Ad Request message in accordance with an embodiment of the present invention. The QAM VOD Ad request message 402 includes the following exemplary information: publisher Identifier (ID); an Ad Opportunity Identifier (ID); Quantity of Ad opportunities (e.g., quantity of 1); timing information for the placement of the Ad (e.g., when ad will be presented, length of ad opportunity); price floor information for the Ad (minimum price required for a winning bid response); device information (e.g., device type (e.g., QAM device, IP device, set-top box, mobile device, smart TV), manufacturer, hardware version, software version, operating system information, MAC Address, etc.); IP address of IP device located at the same customer premises as the QAM device; filtering information (e.g., blacklist and/or whitelist of advertisers/marketers, information on VOD content into which ad will be inserted (audience rating G, PG, PG-13, R, X, mature, violence, sexual) used to filter ad content so that winning bid response has acceptable content), information on ad content that is acceptable (e.g., particular audience content ratings for ad, non-political ad, no pharmaceutical ad), etc.; Ad requirements/specifications (e.g., media content format requirements).

The QAM VOD Ad request message 404 is an exemplary QAM VOD Ad Request message which does not practice the present invention as it does not include an IP address. The QAM VOD Ad request message 404 is in the form of a Hypertext Transfer Protocol request message.

The QAM VOD Ad request message 406 is an exemplary QAM Ad Request message in accordance with an embodiment of the present invention. It is in the same QAM VOD Ad request message as QAM VOD Ad request message 404 but includes the IP address 408 of an IP device (e.g., an IP streaming device such a ROKU device) located at the same customer premises as the QAM device for which the QAM VOD Ad request message 406 is being sent. The QAM VOD Ad request message 406 is also in the form of a Hypertext Transfer Protocol request message.

In some embodiments, the SSP (e.g., SSP 110) to which an Ad Request is sent has an application programming interface which identifies the various fields and information that is to be included in the Ad Request as well as fields and information which are optional. In some embodiments, the Ad Server (e.g., Ad Server 124) includes a software application or plugin that is downloaded from the SSP (e.g., SSP 110) which includes the API software for exchanging information (e.g., Ad requests, responses, information on bid and response matching rules to be applied, billing information, etc.) between the Ad server and SSP.

In some embodiments, the Ad request (e.g., Ad request 41 of method 200) is in the form of a real-time bid request (e.g., an IAB OpenRTB bid request). In some such embodiments, the SSP which receives the Ad request in the form of a real-time bid request can forward it and/or modify it and then forward it to a DSP for distribution to Marketer Ad Servers.

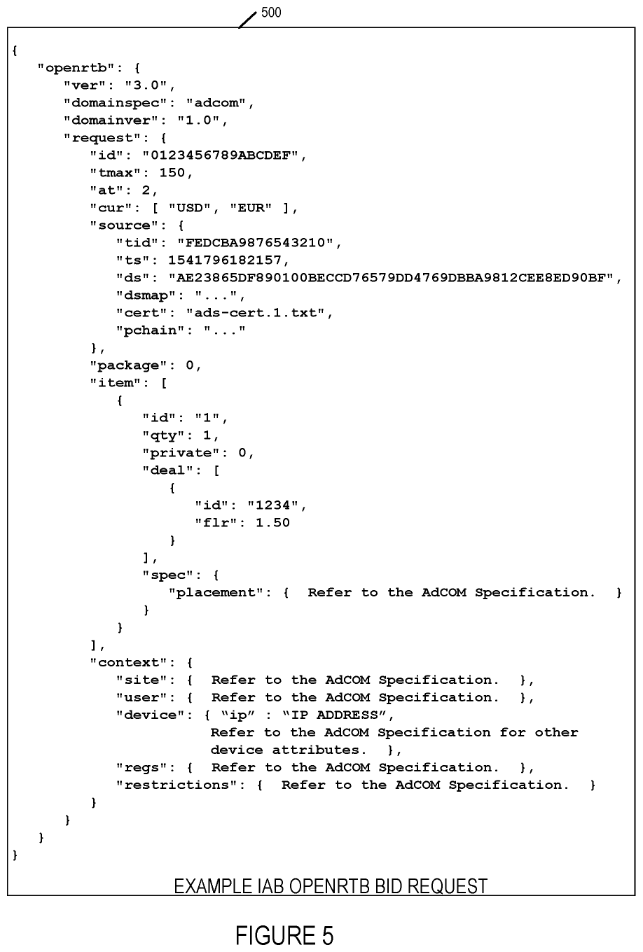

FIG. 5 illustrates an exemplary bid request in accordance with an embodiment of the present invention. The exemplary bid request 500 is an IAB OpenRTB bid request 500 based on the Example IAB OpenRTB included in the Interactive Advertising Bureau (IAB) OpenRTB Specification v3.0 dated March 2022 which is hereby incorporated by reference in its entirety. The context device object of the bid request 500 includes the “ip” attribute which in the example is populated with the IP address of an IP device (e.g., an IP streaming device) co-located in the same customer premises as the QAM device to which the bid request corresponds. For example, if the bid request 500 was for QAM device 1 130 of system 100, the IP address would be IP address 1 which is the IP address of the co-located IP device as both the QAM device 1 and IP device 1 are both located at the first customer premises. In this example, the “ip” attribute refers to an IPV4 address. If the IP address was an IPV6 address “ip” would be replaced with “ipv6”. Additional attributes for the “device” object are defined in the AdCOM Specification. The attributes for the context “site”, “user”, “regs”, and “restrictions” objects are also included in the AdCOM Specification. The attributes for the “item” “spec” “placement” object are also included the AdCOM specification. The AdCOM specification v1.0 dated March 2022 is incorporated by reference in its entirety. Additional information about the bid request 500 can be found in the Interactive Advertising Bureau (IAB) OpenRTB Specification v3.0 dated March 2022

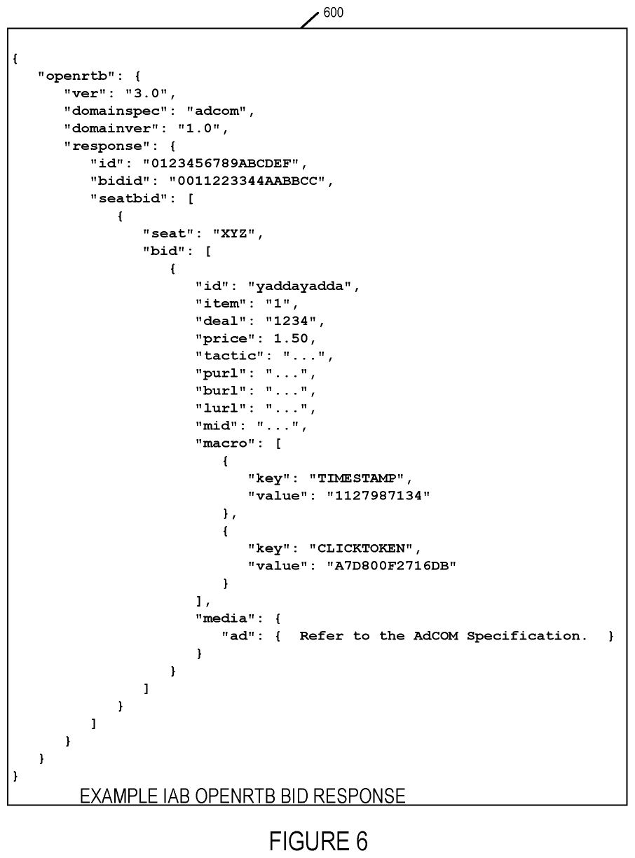

FIG. 6 illustrates an exemplary bid response 600 in accordance with an embodiment of the present invention. The exemplary bid response 600 is the example IAB OpenRTB bid response included in the Interactive Advertising Bureau (IAB) OpenRTB Specification v3.0 dated March 2022. Additional information about the bid response 600 Interactive Advertising Bureau (IAB) OpenRTB Specification v3.0 dated March 2022.

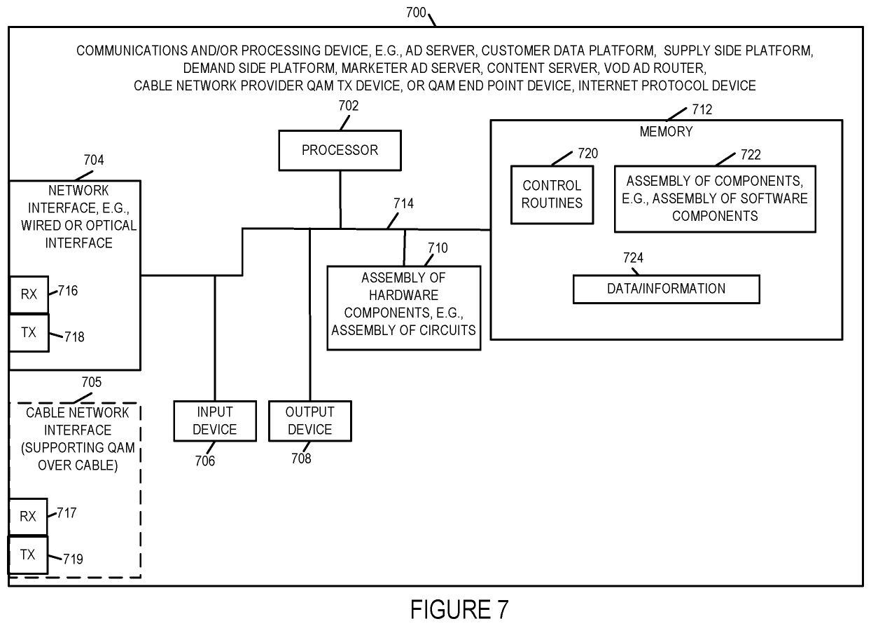

FIG. 7 is a drawing of an exemplary communications and/or processing device 700 in accordance with an exemplary embodiment. Exemplary communications and/or processing device 700 is any of QAM device 1 130, QAM device 2 134, . . . , QAM device N 140, IP device 1 132, IP device 2, 138, . . . , IP device N 143, display device 1 128, display device 2 136, . . . , display device N 142, Content Server 121, VOD Ad router 122, Ad Server 124, Customer Data Platform 126, Supply Side Platform 110, Demand Side Platform 112, Marketer Ad Server 1 114, Marketer Ad Server 2 116, . . . , Marketer Ad Server M 118, IP network protocol system of system 100 of FIG. 1 and FIG. 2 or the method 300. Communications and/or processing device 700 includes a processor 702, e.g., a CPU, a network interface 704, an input device 706, e.g., a keyboard, an output device 708, e.g., a display, an assembly of hardware components 710, e.g., an assembly of circuits, and memory 712 coupled together via a bus 714 over which the various elements may interchange data and information.

Network interface 704, e.g., a wired or optical interface, includes a receiver 716 and a transmitter 718 via which the device 700 communicates with other devices. Network interface 704 couples the communications and/or processing device 700 to other network nodes, network communications links and/or the Internet.

In some embodiments, e.g., an embodiment in which device 700 is one of a cable network service provider QAM TX device (e.g., content server 121) or a QAM end point device (e.g., QAM devices 1, 2, . . . , N), device 700 further includes cable network interface 705 supporting QAM signaling over cable. Cable network interface 705 includes a receiver 717 and a transmitter 719.

Memory 712 includes a control routine 720, an assembly of components 622, e.g., an assembly of software components, and data/information 724. Control routines 720 is, e.g., a routine which handles basic device functions including boot-up, memory access, interface control, etc. In some embodiments, the control routines 720 includes instructions which control the operation of the communications device and/or processing device 700 to perform one or more operations and/or steps of various methods discussed herein. Assembly of components 722 includes, e.g., software, routines, sub-routines, applications, etc., which, when executed by a processor, e.g., processor 702, implement one or more steps of an exemplary method performed by device 700, e.g., steps shown and/or described with respect to a particular type of device 700, e.g. a QAM device (e.g., QAM device 1 130), an IP device (e.g., IP device 132), content server (e.g., content server 121), VOD Ad router (e.g., VOD Ad router 122), an Ad Server (e.g., AD Server 124), a Customer Data Platform server (e.g., Customer Data Platform 126, a Supply Side Platform server (e.g., Supply Side Platform 110, a Demand Side Platform server (e.g., DSP 112), Marketer Ad Server (e.g., Marketer Ad server 1 114), a display device (e.g., display device 1 128), cable network provider QAM TX device, or QAM end point device of system 100 of FIGS. 1 and 2, and/or discussed herein for example in connection with methods 200 and/or 300 of FIGS. 2 and 3 respectively.

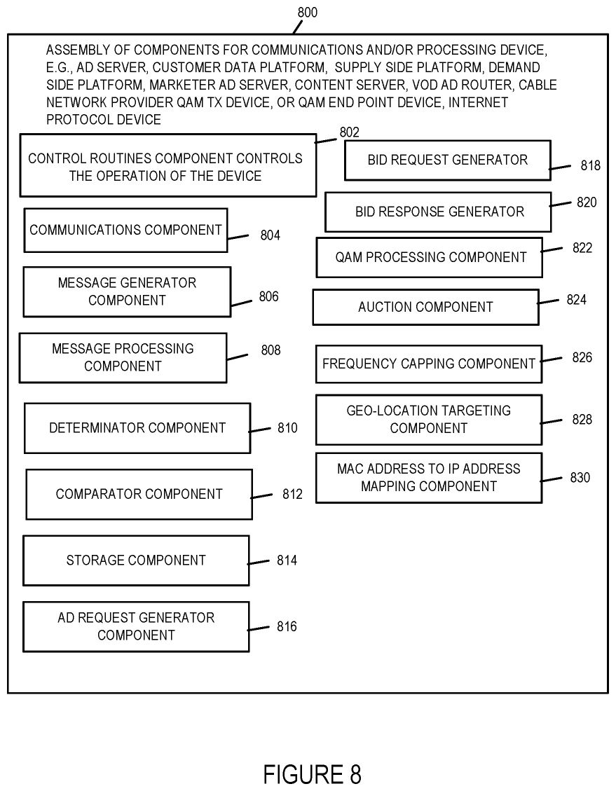

FIG. 8 is a drawing of an exemplary assembly of components 800 which may be included in an exemplary communications and/or processing device, e.g., communications and/or processing device 700 of FIG. 7, in accordance with an exemplary embodiment. The components in the assembly of components 800 can, and in some embodiments are, implemented fully in hardware within a processor, e.g., processor 702, e.g., as individual circuits. The components in the assembly of components 800 can, and in some embodiments are, implemented fully in hardware within the assembly of hardware components 710, e.g., as individual circuits corresponding to the different components. In other embodiments some of the components are implemented, e.g., as circuits, within processor 702 with other components being implemented, e.g., as circuits within assembly of components 710, external to and coupled to the processor 702. As should be appreciated the level of integration of components on the processor and/or with some components being external to the processor may be one of design choice. Alternatively, rather than being implemented as circuits, all or some of the components may be implemented in software and stored in the memory 712 of the device 700, with the components controlling operation of device 700 to implement the functions corresponding to the components when the components are executed by a processor e.g., processor 702. In some such embodiments, the assembly of components 800 is included in the memory 712 as assembly of software components 722. In still other embodiments, various components in assembly of components 800 are implemented as a combination of hardware and software, e.g., with another circuit external to the processor providing input to the processor which then under software control operates to perform a portion of a component's function. When implemented in software the components include code, which when executed by a processor, e.g., processor 702, configure the processor to implement the function corresponding to the component. In embodiments where the assembly of components 800 is stored in the memory 712, the memory 712 is a computer program product comprising a computer readable medium comprising code, e.g., individual code for each component, for causing at least one computer, e.g., processor 702, to implement the functions to which the components correspond.

Completely hardware based or completely software based components may be used. However, it should be appreciated that any combination of software and hardware, e.g., circuit implemented components may be used to implement the functions. As should be appreciated, the components illustrated in FIG. 8 control and/or configure the device 700 or elements therein such as the processor 702, to perform the functions of corresponding steps illustrated and/or described in the method of one or more of the flowcharts, signaling diagrams and/or described with respect to any of the Figures. Thus the assembly of components 800 includes various components that perform functions of corresponding one or more described and/or illustrated steps of an exemplary method.

Assembly of components 800 includes a control routines component 802, a communications component 804, a message generator component 806, a message processing component 808, a determinator component 810, a comparator component 812, a storage component 814, an Ad request generator component 816, a bid request generator component 818, a bid response generator component 820, a QAM content delivery component 822, an auction component 824, a frequency capping component 826, a geo-location targeting component 828, MAC address to IP address mapping component 830,

The control routines component 802 is configured to control operation of the device 800.

The communications component 804 is configured to handle communications, e.g., receipt and transmission of signals and provide protocol signal processing for one or more protocols for the device.

The message generator component 806 is configured to generate messages (e.g., VOD request messages, Ad request messages, bid request messages, bid response messages, content delivery messages) for transmission. In some embodiments, the message generator component 806 is a sub-component of the communications component 804.

The message processing component 808 processes received messages, e.g., requests for information, Ad Request messages, ad bid request messages, query messages (e.g., query messages to look up and return an IP address associated with a MAC address). In some embodiments, the message processing component 808 is a sub-component of the communications component 804.

The determinator component 810 makes determination for the device such as for example, determining whether or not to respond to an ad bid request message, determining an IP address associated with a MAC address, determining a geo-location based on an IP address, determining information to be included in a bid request, determining information to be included in a bid response, determining ad content for a ad bid response based on an IP address and/or a geo-location, determining ad content not to be included in an ad bid response based on an IP address and/or a geo-location, determining information corresponding to an IP address for example geo-location, determining price to include in an ad bid response, determining the winning bid response from a plurality of bid responses, determining if frequency capping is to be implemented, determining whether to refrain from making a bid response to bid request, determining IP addresses for an advertising targeting campaign, etc.

The comparator component 812 is configured to perform comparison of information and data such as for example, MAC addresses during an IP address table lookup, bid responses, bid prices, bid response parameters vs. filtering parameters, etc.

The storage component 814 is configured to perform all operations in storing and retrieving instructions and/or information, e.g., MAC address information for QAM devices, IP address information for IP devices, Household identifier information, data/information associating, correlating, and/or mapping QAM device MAC addresses to IP device IP addresses located at the same customer premises and also household identifiers for the same customer premises, storing ad requests, bid requests, bid responses, VOD content, messages, winning bid responses, information corresponding to an IP address, etc.

The Ad request generator component 816 generates Ad requests such as for example QAM VOD Ad requests, Ad requests including a MAC address, Ad requests including an IP address, etc. In some embodiments, the Ad request generator component is a sub-component of the message generator component 806 or the communications component 804.

The bid request generator component 818 generates bid requests for ad space or ad opportunities such as for example IAB OpenRTB bid requests. In some embodiments, the bid request generator component 818 is a sub-component of the Ad request generator component 816, the message generator component 806 or the communications component 804.

The bid response generator component 820 generates bid responses for ad space such as for example IAB OpenRTB bid responses. In some embodiments, the bid response generator component 820 is a sub-component of the Ad request generator component 816, the message generator component 806 or the communications component 804.

The QAM processing component 822 performs processing of content and/or signals received as QAM signals and signals and/or content to be transmitted as QAM signals including the transcoding of signals. In some embodiments, the QAM processing component 822 is a sub-component of the communications component 804.

The auction component 824 performs programmatic advertising electronic auctions of ad opportunities or ad space via the processing of ad bid requests and ad bid responses to determine a winning bid response for auctioned ad opportunity or ad space based on matching rules.

The frequency capping component 826 performs operations to limit the number of times the same ad or an ad for the same product or service is presented to an advertising target (e.g., a device or household associated with an IP address) within a time period.

The geo-location targeting component performs operations to identify ad campaign targets and/or ad content for bid responses based on geo-location information corresponding to, derived from, and/or based on IP address information.

The MAC address to IP address mapping component 830 maps and/or associates QAM device MAC addresses with IP device IP addresses (e.g., based on the location of the QAM device and the IP device being co-located at the same customer premises and/or belonging to the same Household).

It is to be understood that not all components need to be included in each communications and/or processing device but that the specific components included will depend on the functions and/or operations that specific communications and/or processing device is to perform. For example, an Ad server need not include the bid response generator component 820 as it will not be responding to bid requests.

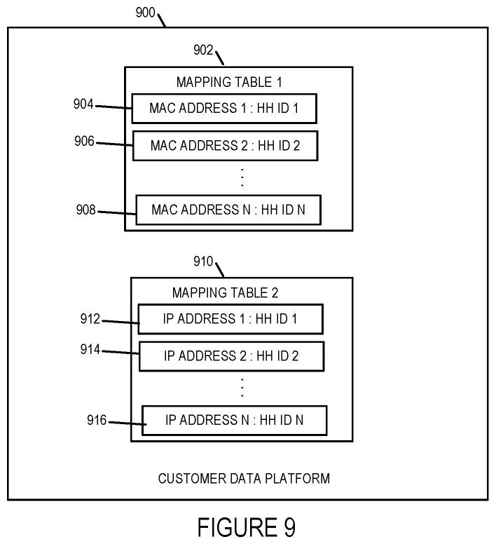

In various embodiments, one or more of the devices, apparatus, systems and/or platforms of system 100 of FIG. 1 are implemented as virtual devices or applications executing on one or nodes including processing hardware in a cloud environment. FIG. 9 illustrates an exemplary customer data platform 900 including a first mapping table 902 and a second mapping table 910. In some embodiments, the customer data platform 126 uses two mapping tables as shown in customer data platform 900.

The first mapping table includes entries 904, 906, and 908. The entry 904 maps the MAC address 1 to HouseHold (HH) ID 1. The entry 906 maps the MAC address 2 to HouseHold ID 2. The entry 908 maps the MAC address N to the HouseHold ID N.

The second mapping table includes the entries 912, 914 and 916. The second mapping table entry 912 maps the IP address 1 to the HouseHold ID 1. The second mapping table entry 914 maps the IP address 2 to the HouseHold ID 2. The second mapping table entry 916 maps the IP address N to the HouseHold ID N.

In response to a request to determine the IP address associated with the MAC address 1, the customer data platform first performs a first table lookup in the first mapping table using the MAC address 1 value to find the HH ID to which it maps which in this case is HH ID 1. The customer data platform then performs a second table lookup in the second mapping table using the identified HH ID 1 to find the IP address to which it is mapped which in this example is IP address 1. In various embodiments, the first mapping table is generated by the cable network system and provided to the customer data platform while the second mapping table is generated by the IP network system and provided to the customer data platform.

Various exemplary numbered embodiments illustrating different features of the present invention will now be discussed. The various features discussed may be used in variety of different combinations. The numbered embodiments are only exemplary and are not meant to be limiting to the scope of the invention. The various method embodiments may be, and in some embodiments are, implemented on system 100 of FIG. 1.

### LIST OF EXEMPLARY NUMBERED METHOD EMBODIMENTS

Method Embodiment 1. A method of providing content to a user of a first Quadrature Amplitude Modulation (QAM) customer premises device located at a first customer premises, the method comprising: storing information (e.g., in a storage device included in a customer data platform of a cable service provider) associating a first Media Access Control (MAC) address of the first QAM customer premises device located at the first customer premises with a first Internet Protocol (IP) address corresponding to the first customer premises; receiving, at a network equipment device (e.g., a VOD ad router or an advertisement (ad) server), a first message (e.g., message 18 of method 200 or message 224 of method 1000), including information identifying an opportunity for the presentation of content (e.g., an ad) and the first MAC address, said first message not including the first IP address; determining an IP address corresponding to the first MAC address from the stored information (e.g., by operating the network equipment device (e.g., VOD ad router or the ad server) to contact a customer data platform to request IP address information corresponding to the first MAC address and receiving from the customer data platform an IP address corresponding to the first MAC address from the stored information); generating (e.g., at the network equipment device (e.g., the ad router or the ad server)) an advertisement (ad) request (e.g., a request for an ad impression or an opportunity to display an ad (e.g., ad request message 36 of method 200 or ad request message 41 of method 1000)), said ad request including the first IP address; and communicating the generated ad request including the first IP address to a supply side platform (SSP) (e.g., from VOD Ad router 122 via the Ad server 124 to SSP 110 in method 200 and directly from the Ad server 124 to the SSP 110 in method 1000).
Method Embodiment 1A. The method of Method Embodiment 1, wherein an operator operates both a cable network system providing QAM sessions to the first QAM customer premises device located at the first customer premises and an Internet Protocol network system providing Internet services to a first IP device (e.g., an IP streaming device) with the first IP address also located at the first customer premises; wherein the cable network system's distribution network for providing QAM sessions to the first QAM customer premises device is separate and different from the Internet Protocol network system's distribution network through which content is provided to the first IP device; and wherein the operator uses a household identifier to identify the first customer premises.
Method Embodiment 1B. The method of Method Embodiment 1, wherein the network equipment device is a Video-on-Demand (VOD) ad router or an Ad server.
Method Embodiment 1C. The method of Method Embodiment 1, wherein the network equipment device is the VOD ad router; and wherein said VOD ad router generates said ad request; and wherein said communicating the generated ad request including the first IP address to a supply side platform (SSP) includes communicating the ad request from the VOD ad router to the SSP via an Ad server.
Method Embodiment 1D. The method of Method Embodiment 1C, further comprising: modifying by the ad server the ad request as the ad request is communicated to the SSP, said modifying including re-formatting the ad request and/or, adding, deleting and/or changing information about the opportunity to present an ad (e.g., adding information for generating a real-time bid request, filtering information, information about requirements for the ad impression, bid pricing information, publisher identification information, etc.).
Method Embodiment 1E. The method of Method Embodiment 1, wherein the network equipment device is an Ad server; and wherein the first message including the first MAC address and information identifying an opportunity for the presentation of content (e.g., an ad) to the first QAM customer premises device is an ad request message including the first MAC address which is received by the Ad server from an Ad router.
Method Embodiment 1F. A method of providing content to a user of a first Quadrature Amplitude Modulation (QAM) customer premises device located at a first customer premises, the method comprising: storing information (e.g., in a storage device included in a customer data platform of a cable service provider) associating a first Media Access Control (MAC) address of the first QAM customer premises device located at the first customer premises with a first Internet Protocol (IP) address corresponding to the first customer premises; receiving, at a cable network system, a request for Video-on-Demand content including the first MAC address, said request for Video-on-Demand content not including the first IP address; determining, by the cable network system, an IP address corresponding to the first MAC address from the stored information (e.g., by querying the customer data platform to request IP address information corresponding to the first MAC address and obtaining from the customer data platform an IP address corresponding to the first MAC address from the stored information); generating, by the cable network system (e.g., by an ad router and/or an ad server of the cable network system) an advertisement (ad) request (e.g., a request for an ad impression or an opportunity to display an ad), said ad request including the first IP address; and communicating the generated ad request including the first IP address to a supply side platform (SSP).
Method Embodiment 2. The method of Method Embodiment 1, further comprising: receiving, at an ad server, from the SSP information (e.g., a winning bid response to an advertisement bid request) identifying content (e.g., an advertisement, creative or media content for an impression corresponding to the winning bid response) to be supplied to the first QAM customer premise device as part of a QAM session.
Method Embodiment 3. The method of Method Embodiment 2, further comprising: operating the ad server to initiate delivery of the identified content in the QAM session to the first QAM customer premises device.
Method Embodiment 4. The method of Method Embodiment 3, wherein said QAM session is a Video-on-Demand (VOD) session which was initiated by the first QAM customer premises device by sending a VOD request message to a network headend, said VOD request message including the first MAC address.
Method Embodiment 5. The method of Method Embodiment 1, wherein said first IP address is an IP address of an IP device located at the first customer premises (e.g., an IP video streaming device or another IP device).
Method Embodiment 6. The method of Method Embodiment 5, wherein storing information (e.g., in a storage device included in a customer data platform of a cable service provider) associating a first MAC address of the first QAM customer premises device located at the first customer premises with a first IP address corresponding to the first customer premises includes: storing the first MAC address in a table, said first IP address being associated in said table with the first MAC address (e.g., the association information is the first household identifier which is associated with first IP address in a second table).
Method Embodiment 7. The method of Method Embodiment 6, wherein said table further includes a first household identifier corresponding to the first customer premises used by a cable network service provider to identify a first household to which the first customer premises corresponds.
Method Embodiment 7A. The method of Method Embodiment 7, wherein determining the IP address corresponding to the first MAC address from the stored information includes: determining a household identifier corresponding to the first MAC address, said household identifier corresponding to the first MAC address being the first household identifier; and determining from the determined household identifier an IP address corresponding to the determined household identifier, the determined IP address being the first IP address.
Method Embodiment 8. The method of Method Embodiment 4, wherein operating the ad server to initiate delivery of the identified content in the QAM session to the first QAM customer premises device includes: operating the ad server to send a message to a VOD ad router, said message instructing the VOD Ad router to provide the identified content (e.g., the ad) to a QAM VOD content server for insertion into a QAM VOD content stream being provided to the first QAM customer premises device as part of the QAM VOD session.
Method Embodiment 8A. The method of Method Embodiment 8, wherein the VOD ad router is used to provide the identified content (e.g., the ad) to the VOD content server.
Method Embodiment 9. The method of Method Embodiment 8, further comprising: inserting, by the VOD content server, the identified content (e.g., ad) into the QAM VOD content stream in response to receiving the identified content from the VOD ad router.
Method Embodiment 9A. The method of Method Embodiment 9, further comprising: receiving the identified content (e.g., ad) at the first QAM customer premises device from the VOD content server; outputting the identified content (e.g., ad) to a playback device; outputting the identified content (e.g., ad) from the playback device to the user.
Method Embodiment 9B. The method of Method Embodiment 9A, wherein the QAM customer premises device is a QAM set-top cable box; and wherein the playback device is a display device (e.g., a television set).
Method Embodiment 9C. The method of Method Embodiment 9, further comprising: receiving the identified content (e.g., ad) at the first QAM customer premises device from the VOD content server; and outputting, by the first QAM customer premises device, the identified content to a display.
Method Embodiment 9D. The method of Method Embodiment 9C, wherein the first QAM customer premises device includes the display.
Method Embodiment 10. The method of Method Embodiment 1, further comprising: receiving the ad request at the supply side platform; wherein the ad request includes in addition to the first IP address, one or more of the following: quantity of ad opportunities, publisher identifier information, an ad opportunity identifier, price floor information, device information for the first QAM customer premises device (e.g., device type, manufacturer, operation system version, hardware version, software version, display size), filtering information, specifications for identified content).
Method Embodiment 11. The method of Method Embodiment 1, further comprising: receiving the ad request at the supply side platform; generating, at the supply side platform, a real-time bid request based on information included in the ad request, said real-time bid request including the first IP address; communicating from the supply side platform the real-time bid request to a demand side platform; receiving the real-time bid request at the demand side platform; communicating the real-time bid request from the demand side platform to one or more Marketer Ad Servers; and receiving at the one or more Marketer Ad Servers the communicated real-time bid request.
Method Embodiment 11A. The method of Method Embodiment 11, wherein the real-time bid request is an IAB OpenReal-time bid request (ORTB bid request) (e.g., OpenRTB request in accordance with the OpenRTB protocol (e.g., OpenRTB 3.0 (Real-Time Bidding) specification and/or AdCOM specification v1.0 dated March 2022).
Method Embodiment 11B. The method of Method Embodiment 11, wherein the identified content is an advertisement.
Method Embodiment 12. The method of Method Embodiment 1, wherein the identified content is an advertisement.
Method Embodiment 13. The method of Method Embodiment 11, further comprising: performing by one of the following: the supply side platform, the demand side platform or a Marketer Ad Server a frequency capping operation based on the first IP address included in the real-time bid request.
Method Embodiment 13A. The method of Method Embodiment 13, wherein said frequency capping operation based on the first IP address includes limiting the number of times the same content (e.g., ad) is presented to a device associated with the first IP address in a first period of time.
Method Embodiment 13B. The method of Method Embodiment 13, wherein said frequency capping operation based on the first IP address is performed by a Marketer Ad Server, said frequency capping operation performed by the Marketer Ad Server including: refraining from sending a real-time bid response identifying content (e.g., an ad) that is the same as content (e.g., an ad) previously provided a first threshold number of times within a first period of time to a device associated with the first IP address.
Method Embodiment 13C. The method of Method Embodiment 13, wherein said frequency capping operation based on the first IP address is performed by the demand side platform, said frequency capping operation including: determining, at the demand side platform, whether any real-time bid responses received from Marketer Ad servers in response to the real-time bid request identifies content (e.g., an ad) that is the same as content (e.g., an ad) previously provided a first threshold number of times within a first period of time to a device associated with the first IP address; and in response to determining that one or more of the real-time bid responses received from the Marketer Ad servers in response to the real-time bid request do identify content (e.g., an ad) that is the same as content (e.g., an ad) previously provided a first threshold number of times within a first period of time to a device associated with the first IP address, refraining, by the demand side platform, from sending the one or more determined real-time bid responses to the sell side platform in response to the real-time bid request.
Method Embodiment 13D. The method of Method Embodiment 13, wherein said frequency capping operation based on the first IP address is performed by a supply side platform, said frequency capping operation including excluding real-time bid responses which identify content (e.g., an ad) that is the same as content (e.g., an ad) previously provided a first threshold number of times within a first period of time to a device associated with the first IP address received in response to the real-time bid request from being selected as a winning bid response to the real-time bid request.
Method Embodiment 14. The method of Method Embodiment 11, further comprising: using, by one or more of the Marketer Ad servers which receive the real-time bid request, the first IP address included in the real-time bid request to perform addressable audience targeting advertising.
Method Embodiment 14A. The method of Method Embodiment 14, wherein performing addressable audience targeting advertising includes: determining advertising content (e.g., specific ad content such as a Ford commercial for F-150 trucks) to include in a real-time bid response to the real-time bid request based on information corresponding to the first IP address (e.g., information about prior clicks on Ford website links requesting information on pricing and options of Ford F-150 trucks for sale).
Method Embodiment 14B. The method of Method Embodiment 14A, wherein said information corresponding to the first IP address is proprietary first party data of the marketer operating the Marketer Ad server.
Method Embodiment 15. The method of Method Embodiment 11, further comprising: using, by one or more of the Marketer Ad servers which receive the real-time bid request, the first IP address included in the real-time bid request to implement geo-location based targeted advertising.
Method Embodiment 16. The method of Method Embodiment 11, further comprising: determining, by a first Marketer Ad server which received the real-time bid request, a geo-location corresponding to the first IP address; and determining, by the first Marketer Ad server, whether or not to send a real-time bid response in response to the real-time bid request based on the determined geo-location.
Method Embodiment 17. The method of Method Embodiment 14, further comprising: determining, by a first Marketer Ad server which received the real-time bid request, a geo-location corresponding to the first IP address; and determining, by the first Marketer Ad server, content (e.g., ad content) to include in a real-time bid response in response to the real-time bid request based on the determined geo-location (e.g., ad content for an amusement park is included if the geo-location corresponding to the first IP address is within 50 miles of the location of the amusement park, ad content for a politician is included if the geo-location corresponding to the first IP address is within the voting district for the politician).
Method Embodiment 18. The method of Method Embodiment 14, further comprising: determining, by a first Marketer Ad server which received the real-time bid request, a geo-location corresponding to the first IP address; and determining, by the first Marketer Ad server, content (e.g., ad content) to not include in a real-time bid response in response to the real-time bid request based on the determined geo-location (e.g., ad content for an amusement park is not included if the geo-location corresponding to the first IP address is farther than 50 miles from the location of the amusement park, ad content for a politician is not included if the geo-location corresponding to the first IP address is not within the voting district for the politician).
Method Embodiment 19. The method of Method Embodiment 11, further comprising: using, by a first Marketer Ad server which receives the real-time bid request, first party data of the first Marketer Ad server operator corresponding to the first IP address included in the real-time bid request to implement geo-location based targeted advertising without first party data of the cable network operator which is to supply the identified content (e.g., ad) in a winning bid response to the first QAM device.
Method Embodiment 20. The method of Method Embodiment 11, further comprising: obtaining, by a first Marketer Ad server, which receives the real-time bid request, information about the first IP address (e.g., first party information of the first Marketer Ad server stored in a storage device connected to or part of the first Marketer Ad server), said information not being obtained from a cable network operator operating the network equipment device which generated the ad request; and using, by the first Marketer Ad server, the obtained information in determining whether or not to submit a real-time bid response in response to the real-time bid request.
Method Embodiment 21. The method of Method Embodiment 11, further comprising: obtaining, by a first Marketer Ad server, which receives the real-time bid request, information about the first IP address (e.g., first party information of the first Marketer Ad server stored in a storage device connected to or part of the first Marketer Ad server), said information not being obtained from a cable network operator operating the network equipment device which generated the ad request; and using, by the first Marketer Ad server, the obtained information in determining a price and/or content (e.g., ad content) to include in a real-time bid response in response to the real-time bid request.
Method Embodiment 22. The method of Method Embodiment 11, generating, at one or more of the Marketer Ad Servers that received the communicated real-time bid request, a real-time bid response to the real-time bid request, each of said real-time bid responses generated including information identifying content (e.g., ad content of the individual marketer generating the real-time bid response) to be supplied to the first QAM customer premises device as part of a QAM session and a price; and communicating, by each of the Marketer Ad Servers which generated real-time bid responses, the generated real-time bid response to the demand side platform (DSP) in response to the real-time bid request; receiving the real-time bid responses from each of the Marketer Ad Servers at the DSP; and communicating the real-time bid responses from the DSP to the SSP in response to the real-time bid request received from the SSP.
Method Embodiment 23. The method of Method Embodiment 22, receiving at the SSP the real-time bid responses from the DSP; determining which of the received real-time bid responses is the winning real-time bid response based on information contained in the real-time bid response and/or the ad request (e.g., applying filtering, frequency capping, pacing instructions provided in the ad request); and communicating from SSP to the Ad server the information (e.g., the winning bid response) identifying content to be supplied to the first QAM customer premises device as part of the QAM session.
Method Embodiment 24. The method of Method Embodiment 1, wherein the ad request is a real time bid request; and wherein the first IP address is included in a device object of the real-time bid request (e.g., the first IP address being included in the ip or ipv6 attribute of the device object included in an Interactive Advertising Bureau (IAB) OpenRTB bid request in compliance with AdCOM specification v1.0 dated March 2022).
Method Embodiment 24A. The method of Method Embodiment 24, wherein the real-time bid request is an IAB OpenReal-time bid request (ORTB bid request) (e.g., OpenRTB request in accordance with the OpenRTB protocol (e.g., OpenRTB 3.0 (Real-Time Bidding) specification and/or AdCOM specification v1.0 dated March 2022)).
Method Embodiment 25. The method of Method Embodiment 22, wherein the first IP address is included in a device object of the real-time bid request (e.g., the first IP address being included in the ip or ipv6 attribute of the device object included in an Interactive Advertising Bureau (IAB) OpenRTB bid request in compliance with AdCOM specification v1.0 dated March 2022).
Method Embodiment 25A. The method of Method Embodiment 25, wherein the real-time bid request is an IAB OpenReal-time bid request (ORTB bid request) (e.g., OpenRTB request in accordance with the OpenRTB protocol (e.g., OpenRTB 3.0 (Real-Time Bidding) specification and/or AdCOM specification v1.0 dated March 2022).
Method Embodiment 25B. The method of Method Embodiment 25A, wherein one or more of the real-time bid responses are OpenRTB bid responses (e.g., OpenRTB responses in accordance with the OpenRTB protocol (e.g., OpenRTB 3.0 (Real-Time Bidding) specification and/or AdCOM specification v1.0 dated March 2022).
Method Embodiment 26. The method of Method Embodiment 1, wherein the ad request is a hypertext protocol message.

### LIST OF EXEMPLARY NUMBERED SYSTEM EMBODIMENTS

System Embodiment 1. A system for providing content to a user of a first Quadrature Amplitude Modulation (QAM) customer premises device located at a first customer premises, the system comprising: a network equipment device, said network equipment device including: memory; and a first processor, said first processor controlling the network equipment device to perform the following operations: receiving, at the network equipment device, a first message including information identifying an opportunity for the presentation of content (e.g., an ad) and a first MAC address, said first message not including a first IP address; determining a first IP address corresponding to the first MAC address from stored information (e.g., by operating the network equipment device to contact a customer data platform to request IP address information corresponding to the first MAC address and receiving from the customer data platform an IP address corresponding to the first MAC address from stored information in the customer data platform, said IP address being the first IP address), said stored information associating the first Media Access Control (MAC) address of the first QAM customer premises device located at the first customer premises with a first Internet Protocol (IP) address corresponding to the first customer premises; generating (e.g., at the network equipment device) an advertisement (ad) request (e.g., a request for an ad impression or an opportunity to display an ad) including the first IP address; and communicating the generated ad request including the first IP address to a supply side platform (SSP).
System Embodiment 1A. The system of System Embodiment 1, wherein an operator operates both a cable network system providing QAM sessions to the first QAM customer premises device located at the first customer premises and an Internet Protocol network system providing Internet services to a first IP device (e.g., an IP streaming device) with the first IP address also located at the first customer premises; wherein the cable network system's distribution network for providing QAM sessions to the first QAM customer premises device is separate and different from the Internet Protocol network system's distribution network through which content is provided to the first IP device; and wherein the operator uses a household identifier to identify the first customer premises.
System Embodiment 1B. The system of System Embodiment 1, wherein the network equipment device is a Video-on-Demand (VOD) ad router or an Ad server.
System Embodiment 1C. The system of System Embodiment 1, wherein the network equipment device is a VOD ad router; and wherein said VOD ad router generates said ad request; and wherein said communicating the generated ad request including the first IP address to a supply side platform (SSP) includes communicating the ad request from the VOD ad router to the SSP via an Ad server.
System Embodiment 1D. The method of System Embodiment 1, wherein the network equipment device is an Ad server; and wherein the first message including information identifying an opportunity for the presentation of content (e.g., an ad) and a first MAC address is an ad request message including the first MAC address but not the first IP address which is received by the Ad server from an Ad router.
System Embodiment 2. The system of System Embodiment 1, further including: an ad server, said ad server including: memory and a second processor, said second processor controlling the ad server to perform the following operation: receiving, at the ad server, from the SSP information (e.g., a winning bid response to an advertisement bid request) identifying content (e.g., an advertisement, creative or media content for an impression corresponding to the winning bid response) to be supplied to the first QAM customer premise device as part of a QAM session; and wherein the network equipment device is a Video-on-Demand (VOD) Ad router, said ad request being generated at the VOD Ad router; wherein said communicating the generated ad request including the first IP address to a supply side platform (SSP) includes communicating the ad request from the VOD ad router to the SSP via the Ad server.
System Embodiment 3. The system of System Embodiment 2, wherein the second processor further controls the ad server to perform the following additional operation: operating the ad server to initiate delivery of the identified content in the QAM session to the first QAM customer premises device.
System Embodiment 4. The system of System Embodiment 3, wherein said QAM session is a Video-on-Demand (VOD) session which was initiated by the first QAM customer premises device by sending a VOD request message to a network headend, said VOD request message including the first MAC address.
System Embodiment 5. The system of System Embodiment 1, wherein said first IP address is an IP address of an IP device located at the first customer premises (e.g., an IP video streaming device or another IP device).
System Embodiment 6. The system of System Embodiment 5, further comprising: a customer data platform, said customer data platform including a memory and a third processor, said third processor controlling the customer data platform to perform the following operation: storing in memory of the customer data platform or a storage device attached to the customer data platform the information associating the first Media Access Control (MAC) address of the first QAM customer premises device located at the first customer premises with a first Internet Protocol (IP) address corresponding to the first customer premises.
System Embodiment 7. The system of System Embodiment 6, wherein said storing in memory of the customer data platform or a storage device attached to the customer data platform the information associating the first Media Access Control (MAC) address of the first QAM customer premises device located at the first customer premises with a first Internet Protocol (IP) address corresponding to the first customer premises includes: storing the first MAC address in a table, said first IP address being associated in said table with the first MAC address (e.g., the association information is the first household identifier which is associated with first IP address in a second table).
System Embodiment 8. The system of System Embodiment 7, wherein said table further includes a first household identifier corresponding to the first customer premises used by a cable network service provider to identify a first household to which the first customer premises corresponds.
System Embodiment 8A. The system of System Embodiment 7, wherein determining the IP address corresponding to the first MAC address from the stored information includes: determining a household identifier corresponding to the first MAC address, said household identifier corresponding to the first MAC address being the first household identifier; and determining from the determined household identifier an IP address corresponding to the determined household identifier, the determined IP address being the first IP address.
System Embodiment 9. The system of System Embodiment 4, further comprising: a QAM Video-on-Demand (VOD) content server, said QAM VOD content server including memory and a fourth processor; wherein operating the ad server to initiate delivery of the identified content in the QAM session to the first QAM customer premises device includes: operating the ad server to send a message to the VOD ad router, said message instructing the VOD Ad router to provide the identified content (e.g., the ad) to the QAM VOD content server for insertion into a QAM VOD content stream being provided to the first QAM customer premises device as part of the QAM VOD session.
System Embodiment 9A. The system of System Embodiment 9, wherein the VOD ad router is used to provide the identified content (e.g., the ad) to the QAM VOD content server.
System Embodiment 10. The system of System Embodiment 9, wherein the fourth processor controls the QAM VOD content server to perform the operation of: inserting, by the QAM VOD content server, the identified content (e.g., ad) into the QAM VOD content stream in response to receiving the identified content from the VOD ad router.
10A. The system of System Embodiment 10, wherein the identified content (e.g., ad) is received at the first QAM customer premises device from the QAM VOD content server; wherein the identified content (e.g., ad) is outputted from the first QAM customer premises device to a playback device; and wherein the identified content (e.g., ad) is outputted from the playback device to the user.
System Embodiment 10B. The system of System Embodiment 10A, wherein the QAM customer premises device is a QAM set-top cable box; and wherein the playback device is a display device (e.g., a television set).
System Embodiment 10C. The system of System Embodiment 10, wherein the identified content (e.g., ad) is received by the first QAM customer premises device from the QAM VOD content server; and wherein the first QAM customer premises device outputs the received identified content to a display.
System Embodiment 10D. The system of System Embodiment 10C, wherein the first QAM customer premises device includes the display.
System Embodiment 11. The system of System Embodiment 1, further comprising: a supply side platform; wherein the supply side platform receives the ad request; wherein the ad request includes in addition to the first IP address, one or more of the following: quantity of ad opportunities, publisher identifier information, an ad opportunity identifier, price floor information, device information for the first QAM customer premises device (e.g., device type, manufacturer, operation system version, hardware version, software version, display size), filtering information, specifications for identified content).
System Embodiment 12. The system of System Embodiment 1, wherein the supply side platform includes a processor that controls the supply side platform to perform the following operations: receiving the ad request; generating a real-time bid request based on information included in the ad request, said real-time bid request including the first IP address; communicating from the supply side platform the real-time bid request to a demand side platform; wherein the demand side platform includes a processor that controls the demand side platform to perform the following operations: receiving the real-time bid request at the demand side platform; communicating the real-time bid request from the demand side platform to one or more Marketer Ad Servers; and wherein the one or more Marketer Ad Servers receive the communicated real-time bid request.
System Embodiment 12A. The system of System Embodiment 12, wherein the real-time bid request is an IAB OpenReal-time bid request (ORTB bid request) (e.g., OpenRTB request in accordance with the OpenRTB protocol (e.g., OpenRTB 3.0 (Real-Time Bidding) specification and/or AdCOM specification v1.0 dated March 2022).
System Embodiment 12B. The system of System Embodiment 12, wherein the identified content is an advertisement.
System Embodiment 13. The system of System Embodiment 1, wherein the identified content is an advertisement containing video and audio content.
13A. The system of System Embodiment 13, wherein the identified content is a creative.
14. The system of System Embodiment 12, wherein one of the following the supply side platform, the demand side platform or a Marketer Ad Server that received the real-time bid request from the demand side platform perform a frequency capping operation based on the first IP address included in the real-time bid request.
System Embodiment 14A. The system of System Embodiment 14, wherein said frequency capping operation based on the first IP address includes limiting the number of times the same content (e.g., ad) is presented to a device associated with the first IP address in a first period of time.
System Embodiment 14B. The system of System Embodiment 14, wherein said frequency capping operation based on the first IP address is performed by a Marketer Ad Server, said frequency capping operation performed by the Marketer Ad Server including: refraining from sending a real-time bid response identifying content (e.g., an ad) that is the same as content (e.g., an ad) previously provided a first threshold number of times within a first period of time to a device associated with the first IP address.
System Embodiment 14C. The system of System Embodiment 14, wherein said frequency capping operation based on the first IP address is performed by the demand side platform, said frequency capping operation including: determining, at the demand side platform, whether any real-time bid responses received from Marketer Ad servers in response to the real-time bid request identifies content (e.g., an ad) that is the same as content (e.g., an ad) previously provided a first threshold number of times within a first period of time to a device associated with the first IP address; and in response to determining that one or more of the real-time bid responses received from the Marketer Ad servers in response to the real-time bid request do identify content (e.g., an ad) that is the same as content (e.g., an ad) previously provided a first threshold number of times within a first period of time to a device associated with the first IP address, refraining, by the demand side platform, from sending the one or more determined real-time bid responses to the sell side platform in response to the real-time bid request.
System Embodiment 14D. The system of System Embodiment 14, wherein said frequency capping operation based on the first IP address is performed by a supply side platform, said frequency capping operation including excluding real-time bid responses which identify content (e.g., an ad) that is the same as content (e.g., an ad) previously provided a first threshold number of times within a first period of time to a device associated with the first IP address received in response to the real-time bid request from being selected as a winning bid response to the real-time bid request.
System Embodiment 15. The system of System Embodiment 12, wherein the first IP address included in the real-time bid request is used by one or more of the Marketer Ad servers which receive the real-time bid request to perform addressable audience targeting advertising.
System Embodiment 15A. The system of System Embodiment 15, wherein performing addressable audience targeting advertising includes: determining advertising content (e.g., specific ad content such as a Ford commercial for F-150 trucks) to include in a real-time bid response to the real-time bid request based on information corresponding to the first IP address (e.g., information about prior clicks on Ford website links requesting information on pricing and options of Ford F-150 trucks for sale).
15B. The system of System Embodiment 15A, wherein said information corresponding to the first IP address is proprietary first party data of the marketer operating the Marketer Ad server.
System Embodiment 16. The system of System Embodiment 12, wherein the first IP address included in the real-time bid request is used by one or more of the Marketer Ad servers which receive the real-time bid request to implement geo-location based targeted advertising.
System Embodiment 17. The system of System Embodiment 12, wherein a first Marketer Ad server which received the real-time bid request determines a geo-location corresponding to the first IP address; and wherein the first Marketer Ad server determines whether or not to send a real-time bid response in response to the real-time bid request based on the determined geo-location.
System Embodiment 18. The system of System Embodiment 15, wherein a first Marketer Ad server which received the real-time bid request determines a geo-location corresponding to the first IP address; and wherein the first Marketer Ad server determines content (e.g., ad content) to include in a real-time bid response in response to the real-time bid request based on the determined geo-location (e.g., ad content for an amusement park is included if the geo-location corresponding to the first IP address is within 50 miles of the location of the amusement park, ad content for a politician is included if the geo-location corresponding to the first IP address is within the voting district for the politician).
System Embodiment 19. The system of System Embodiment 15, wherein a first Marketer Ad server which received the real-time bid request determines a geo-location corresponding to the first IP address; and wherein the first Marketer Ad server determines content (e.g., ad content) to not include in a real-time bid response in response to the real-time bid request based on the determined geo-location (e.g., ad content for an amusement park is not included if the geo-location corresponding to the first IP address is farther than 50 miles from the location of the amusement park, ad content for a politician is not included if the geo-location corresponding to the first IP address is not within the voting district for the politician).
System Embodiment 20. The system of System Embodiment 12, wherein a first Marketer Ad server which receives the real-time bid request uses first party data of the first Marketer Ad server operator corresponding to the first IP address included in the real-time bid request to implement geo-location based targeted advertising without first party data of the cable network operator which is to supply the identified content (e.g., ad) in a winning bid response to the first QAM device.
System Embodiment 21. The system of System Embodiment 12, wherein a first Marketer Ad server which receives the real-time bid request obtains information about the first IP address (e.g., first party information of the first Marketer Ad server stored in a storage device connected to or part of the first Marketer Ad server), said information not being obtained from a cable network operator operating the network equipment device which generated the ad request; and wherein the first Marketer Ad server uses the obtained information in determining whether or not to submit a real-time bid response in response to the real-time bid request.
System Embodiment 22. The system of System Embodiment 12, wherein a first Marketer Ad server which receives the real-time bid request determines information about the first IP address (e.g., first party information of the first Marketer Ad server stored in a storage device connected to or part of the first Marketer Ad server), said information not being obtained from a cable network operator operating the network equipment device which generated the ad request; and wherein the first Marketer Ad server uses the obtained information in determining a price and/or content (e.g., ad content) to include in a real-time bid response in response to the real-time bid request.
System Embodiment 23. The system of System Embodiment 12, wherein one or more of the Marketer Ad Servers that received the communicated real-time bid request generates a real-time bid response to the real-time bid request, each of said real-time bid responses generated including information identifying content (e.g., ad content of the individual marketer generating the real-time bid response) to be supplied to the first QAM customer premises device as part of a QAM session and a price; and wherein each of the Marketer Ad Servers which generated real-time bid responses communicates the generated real-time bid response to the demand side platform (DSP) in response to the real-time bid request; wherein the real-time bid responses from each of the Marketer Ad Servers is received at the DSP; and wherein the DSP communicates the received real-time bid responses to the SSP in response to the real-time bid request received by the DSP from the SSP.
System Embodiment 24. The system of System Embodiment 23, wherein the processor included in the SSP controls the SSP to perform the following additional operations: receiving at the SSP the real-time bid responses from the DSP; determining which of the received real-time bid responses is the winning real-time bid response based on information contained in the real-time bid response and/or the ad request (e.g., applying filtering, frequency capping, pacing instructions provided in the ad request); and communicating from SSP to the Ad server the information (e.g., the winning bid response) identifying content to be supplied to the first QAM customer premises device as part of the QAM session.
System Embodiment 25. The system of System Embodiment 1, wherein the ad request is a real time bid request; and wherein the first IP address is included in a device object of the real-time bid request (e.g., the first IP address being included in the ip or ipv6 attribute of the device object included in an Interactive Advertising Bureau (IAB) OpenRTB bid request in compliance with AdCOM specification v1.0 dated March 2022).
System Embodiment 25A. The system of System Embodiment 25, wherein the real-time bid request is an IAB OpenReal-time bid request (ORTB bid request) (e.g., OpenRTB request in accordance with the OpenRTB protocol (e.g., OpenRTB 3.0 (Real-Time Bidding) specification and/or AdCOM specification v1.0 dated March 2022).
System Embodiment 26. The system of System Embodiment 23, wherein the first IP address is included in a device object of the real-time bid request (e.g., the first IP address being included in the ip or ipv6 attribute of the device object included in an Interactive Advertising Bureau (IAB) OpenRTB bid request in compliance with AdCOM specification v1.0 dated March 2022).
System Embodiment 26A. The system of System Embodiment 26, wherein the real-time bid request is an IAB OpenReal-time bid request (ORTB bid request) (e.g., OpenRTB request in accordance with the OpenRTB protocol (e.g., OpenRTB 3.0 (Real-Time Bidding) specification and/or AdCOM specification v1.0 dated March 2022).
System Embodiment 26B. The system of System Embodiment 26A, wherein one or more of the real-time bid responses are OpenRTB bid responses (e.g., OpenRTB responses in accordance with the OpenRTB protocol (e.g., OpenRTB 3.0 (Real-Time Bidding) specification and/or AdCOM specification v1.0 dated March 2022).
System Embodiment 27. The system of System Embodiment 1, wherein the ad request is a hypertext protocol message.
System Embodiment 28. The system of System Embodiment 1-27, wherein the SSP is implemented as a SSP server, the customer data platform is implemented as a customer data platform server, and the DSP is implemented as a DSP server.

### LIST OF EXEMPLARY NUMBERED NON-TRANSITORY COMPUTER READABLE MEDIUM EMBODIMENTS

Non-transitory Computer Readable Medium Embodiment 1. A non-transitory computer readable medium including a first set of computer executable instructions which when executed by a processor of a network equipment device cause the network equipment device to perform the steps of: receiving, at the network equipment device, a first message, a first message including information identifying an opportunity for the presentation of content (e.g., an ad) and a first MAC address, said first message not including a first IP address; determining a first IP address corresponding to the first MAC address from stored information (e.g., by operating the network equipment device to contact a customer data platform to request IP address information corresponding to the first MAC address and receiving from the customer data platform an IP address corresponding to the first MAC address from stored information in the customer data platform, said IP address being the first IP address), said stored information associating the first Media Access Control (MAC) address of the first QAM customer premises device located at the first customer premises with a first Internet Protocol (IP) address corresponding to the first customer premises; generating (e.g., at the network equipment device) an advertisement (ad) request (e.g., a request for an ad impression or an opportunity to display an ad) including the first IP address; and communicating the generated ad request including the first IP address to a supply side platform (SSP).
Non-transitory Computer Readable Medium Embodiment 1A.

The non-transitory computer readable medium of Non-transitory Computer Readable Medium Embodiment 1, wherein an operator operates both a cable network system providing QAM sessions to the first QAM customer premises device located at the first customer premises and an Internet Protocol network system providing Internet services to a first IP device (e.g., an IP streaming device) with the first IP address also located at the first customer premises; wherein the cable network system's distribution network for providing QAM sessions to the first QAM customer premises device is separate and different from the Internet Protocol network system's distribution network through which content is provided to the first IP device; and wherein the operator uses a household identifier to identify the first customer premises.
Non-transitory Computer Readable Medium Embodiment 1B. The non-transitory computer readable medium of Non-transitory Computer Readable Medium Embodiment 1, wherein the network equipment device is a Video-on-Demand (VOD) ad router or an Ad server.
Non-transitory Computer Readable Medium Embodiment 1C. The non-transitory computer readable medium of Non-transitory Computer Readable Medium Embodiment 1, wherein the network equipment device is the VOD ad router; and wherein said VOD ad router generates said ad request; and wherein said communicating the generated ad request including the first IP address to a supply side platform (SSP) includes communicating the ad request from the VOD ad router to the SSP via an Ad server.
Non-transitory Computer Readable Medium Embodiment 1D. The non-transitory computer readable medium of Non-transitory Computer Readable Medium Embodiment 1, wherein the network equipment device is an Ad server; and wherein the first message including the first MAC address and information identifying an opportunity for the presentation of content (e.g., an ad) to the first QAM customer premises device is an ad request message including the first MAC address which is received by the Ad server from an Ad router.
Non-transitory Computer Readable Medium Embodiment 2. The non-transitory computer readable medium of Non-transitory Computer Readable Medium Embodiment 1, wherein the network equipment device is an advertisement router; and wherein the first set of computer executable instructions which when executed by the processor of the network equipment device further cause the network equipment device to perform the additional step of: receiving from the SSP via an ad server information identifying content (e.g., an advertisement, creative or media content for an impression corresponding to the winning bid) to be supplied to the first QAM customer premise device as part of a QAM session.
Non-transitory Computer Readable Medium Embodiment 3. The non-transitory computer readable medium of Non-transitory Computer Readable Medium Embodiment 2, wherein the first set of computer executable instructions which when executed by the processor of the advertisement router further cause the advertisement router to perform the additional step of: operating the advertisement router to initiate delivery of the identified content in the QAM session to the first customer premises device.
Non-transitory Computer Readable Medium Embodiment 4.

The non-transitory computer readable medium of Non-transitory Computer Readable Medium Embodiment 3, wherein said QAM session is a Video-on-Demand (VOD) session which was initiated by the first QAM customer premises device by sending a VOD request message to a network headend, said VOD request message including the first MAC address.
Non-transitory Computer Readable Medium Embodiment 5. The non-transitory computer readable medium of Non-transitory Computer Readable Medium Embodiment 1, wherein said first IP address is an IP address of an IP device located at the first customer premises (e.g., an IP video streaming device or another IP device).
Non-transitory Computer Readable Medium Embodiment 6.

The non-transitory computer readable medium of Non-transitory Computer Readable Medium Embodiment 1, wherein the identified content is an ad containing video and audio content.

The techniques of various embodiments may be implemented using software, hardware and/or a combination of software and hardware. Various embodiments are directed to apparatus, e.g., content servers, VOD Ad routers, Ad servers, Demand Side Platforms, Supply Side Platforms, Marketer Ad servers, customer data platforms, IP devices, QAM devices, display devices, Internet Protocol network system equipment, communications devices, IP streaming devices, smart devices, user equipment devices, computers, smartphones, servers, nodes, and/or elements. Various embodiments are also directed to methods, e.g., method of controlling and/or operating e.g., content servers, VOD Ad routers, Ad servers, Demand Side Platforms, Supply Side Platforms, Marketer Ad servers, customer data platforms, IP devices, QAM devices, display devices, Internet Protocol network system equipment, communications devices, IP streaming devices, smart devices, user equipment devices, computers, smartphones, servers, nodes, and/or elements. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order, and are not meant to be limited to the specific order or hierarchy presented. In some embodiments, one or more processors are used to carry out one or more steps of the described methods.

In various embodiments each of the steps or elements of a method are implemented using one or more processors. In some embodiments, each of elements or steps are implemented using hardware circuitry.

In various embodiments devices, e.g., content servers, VOD Ad routers, Ad servers, Demand Side Platforms, Supply Side Platforms, Marketer Ad servers, customer data platforms, IP devices, QAM devices, display devices, Internet Protocol network system equipment, communications devices, IP streaming devices, smart devices, user equipment devices, computers, smartphones, servers, nodes, and/or elements described herein are implemented using one or more components to perform the steps corresponding to one or more methods, for example, generating or creating cell ID lists, GPS information, generating messages, implementing roaming restrictions, comparing data and information, signal processing, sending, comparing, identifying, determining and/or transmission steps. Thus, in some embodiments various features are implemented using components or in some embodiments logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, e.g., content servers, VOD Ad routers, Ad servers, Demand Side Platforms, Supply Side Platforms, Marketer Ad servers, customer data platforms, IP devices, QAM devices, display devices, Internet Protocol network system equipment, communications devices, IP streaming devices, smart devices, user equipment devices, computers, smartphones, servers, nodes, and/or elements are configured to perform the steps of the methods described as being performed by the e.g., content servers, VOD Ad routers, Ad servers, Demand Side Platforms, Supply Side Platforms, Marketer Ad servers, customer data platforms, IP devices, QAM devices, display devices, Internet Protocol network system equipment, communications devices, IP streaming devices, smart devices, user equipment devices, computers, smartphones, servers, nodes, and/or elements. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device, e.g., content server, VOD Ad router, Ad server, Demand Side Platform, Supply Side Platform, Marketer Ad server, customer data platform, IP device, QAM device, display device, Internet Protocol network system equipment, communications device, IP streaming device, smart device, user equipment device, computer, smartphone, server, node, and/or elements, with a processor which includes a component corresponding to each of the steps of the various described methods performed by the device in which the processor is included. In some but not all embodiments a device, e.g., content server, VOD Ad router, Ad server, Demand Side Platform, Supply Side Platform, Marketer Ad server, customer data platform, IP device, QAM device, display device, Internet Protocol network system equipment, communications device, IP streaming device, smart device, user equipment devices computer, smartphone, server, node, and/or element, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above. Depending on the embodiment, the computer program product can, and sometimes does, include different code for each step to be performed. Thus, the computer program product may, and sometimes does, include code for each individual step of a method, e.g., a method of controlling a device, e.g., content servers, VOD Ad routers, Ad servers, Demand Side Platforms, Supply Side Platforms, Marketer Ad servers, customer data platforms, IP devices, QAM devices, display devices, Internet Protocol network system equipment, communications devices, IP streaming devices, smart devices, user equipment devices, computers, smartphones, servers, nodes, and/or elements. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in e.g., content servers, VOD Ad routers, Ad servers, Demand Side Platforms, Supply Side Platforms, Marketer Ad servers, customer data platforms, IP devices, QAM devices, display devices, Internet Protocol network system equipment, communications devices, IP streaming devices, smart devices, user equipment devices, computers, smartphones, servers, nodes, and/or elements or other device described in the present application.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A method of providing content to a user of a first Quadrature Amplitude Modulation (QAM) customer premises device located at a first customer premises, the method comprising:
storing information associating a first Media Access Control (MAC) address of the first QAM customer premises device located at the first customer premises with a first Internet Protocol (IP) address corresponding to the first customer premises;
receiving, at a network equipment device, a first message, said first message including information identifying an opportunity for the presentation of content and the first MAC address, said first message not including the first IP address;
determining an IP address corresponding to the first MAC address from the stored information;
generating an advertisement (ad) request, said ad request including the first IP address; and
communicating the generated ad request including the first IP address to a supply side platform (SSP).

2. The method of claim 1,
wherein the network equipment device is a Video-on-Demand (VOD) ad router;
wherein said VOD ad router generates said ad request; and
wherein the content is an advertisement.

3. The method of claim 1, further comprising:
receiving, at an ad server, from the SSP, information identifying content to be supplied to the first QAM customer premise device as part of a QAM session.

4. The method of claim 3, further comprising:
operating the ad server to initiate delivery of the identified content in the QAM session to the first QAM customer premises device.

5. The method of claim 4, wherein said QAM session is a Video-on-Demand (VOD) session which was initiated by the first QAM customer premises device by sending a VOD request message to a network headend, said VOD request message including the first MAC address.

6. The method of claim 1, wherein said first IP address is an IP address of an IP device located at the first customer premises.

7. The method of claim 6, wherein storing information associating a first MAC address of the first QAM customer premises device located at the first customer premises with a first IP address corresponding to the first customer premises includes:
storing the first MAC address in a table, said first IP address being associated in said table with the first MAC address.

8. The method of claim 7, wherein said table further includes a first household identifier corresponding to the first customer premises used by a cable network service provider to identify a first household to which the first customer premises corresponds.

9. The method of claim 8, wherein determining the IP address corresponding to the first MAC address from the stored information includes:
determining a household identifier corresponding to the first MAC address, said household identifier corresponding to the first MAC address being the first household identifier; and
determining from the determined household identifier an IP address corresponding to the determined household identifier, the determined IP address being the first IP address.

10. The method of claim 5, wherein operating the ad server to initiate delivery of the identified content in the QAM session to the first QAM customer premises device includes:
operating the ad server to send a message to a VOD ad router, said message instructing the VOD Ad router to provide the identified content to a QAM VOD content server for insertion into a QAM VOD content stream being provided to the first QAM customer premises device as part of the QAM VOD session.

11. The method of claim 10, further comprising:
inserting, by the VOD content server, the identified content into the QAM VOD content stream in response to receiving the identified content from the VOD ad router.

12. The method of claim 1, further comprising:
receiving the ad request at the SSP;
generating, at the SSP, a real-time bid request based on information included in the ad request, said real-time bid request including the first IP address;
communicating from the SSP the real-time bid request to a demand side platform;
receiving the real-time bid request at the demand side platform;
communicating the real-time bid request from the demand side platform to one or more Marketer ad servers; and
receiving at the one or more Marketer ad servers the communicated real-time bid request.

13. The method of claim 12, further comprising:
using, by one or more of the Marketer ad servers which receive the real-time bid request, the first IP address included in the real-time bid request to perform addressable audience targeting advertising.

14. A system for providing content to a user of a first Quadrature Amplitude Modulation (QAM) customer premises device located at a first customer premises, the system comprising:
a network equipment device, said network equipment device including:
memory; and
a first processor, said first processor controlling the network equipment device to perform the following operations:
receiving, at the network equipment device, a first message including information identifying an opportunity for the presentation of content and a first Media Access Control (MAC) address, said first message not including a first IP address;
determining a first IP address corresponding to the first MAC address from stored information, said stored information associating the first MAC address of the first QAM customer premises device located at the first customer premises with a first Internet Protocol (IP) address corresponding to the first customer premises;
generating an advertisement (ad) request including the first IP address; and
communicating the generated ad request including the first IP address to a supply side platform (SSP).

15. The system of claim 14,
wherein the network equipment device is a Video-on-Demand (VOD) ad router;
wherein said VOD ad router generates said ad request; and
wherein the content is an advertisement.

16. The system of claim 14, further including:
an ad server, said ad server including: memory and a second processor, said second processor controlling the ad server to perform the following operation:
receiving, at the ad server, from the SSP information identifying content to be supplied to the first QAM customer premise device as part of a QAM session; and
wherein the network equipment device is a Video-on-Demand (VOD) ad router, said ad request being generated at the VOD ad router;
wherein said communicating the generated ad request including the first IP address to a SSP includes communicating the ad request from the VOD ad router to the SSP via the ad server.

17. The system of claim 16, wherein the second processor further controls the ad server to perform the following additional operation:
operating the ad server to initiate delivery of the identified content in the QAM session to the first QAM customer premises device.

18. The system of claim 17, wherein said QAM session is a VOD session which was initiated by the first QAM customer premises device by sending a VOD request message to a network headend, said VOD request message including the first MAC address.

19. The system of claim 14, wherein said first IP address is an IP address of an IP device located at the first customer premises.

20. A non-transitory computer readable medium including a first set of computer executable instructions which when executed by a processor of a network equipment device cause the network equipment device to perform the steps of:
receiving, at the network equipment device, a first message, the first message including information identifying an opportunity for the presentation of content and a first Media Access Control (MAC) address, said first message not including a first IP address;
determining a first IP address corresponding to the first MAC address from stored information, said stored information associating the first MAC address of the first QAM customer premises device located at the first customer premises with a first Internet Protocol (IP) address corresponding to the first customer premises;
generating an advertisement (ad) request including the first IP address; and
communicating the generated ad request including the first IP address to a supply side platform (SSP).
